(19) United States
(12) Patent Application Publication
(10) Pub. No.: US 2014/0273686 A1
(43) Pub. Date: Sep. 18, 2014

(54) TRANSPARENT COMPOSITE SUBSTRATE AND DISPLAY ELEMENT SUBSTRATE

(71) Applicant: SUMITOMO BAKELITE COMPANY LIMITED, Shinagawa-ku, Tokyo (JP)

(72) Inventors: Toshimasa Eguchi, Shinagawa-ku (JP); Hideo Umeda, Shinagawa-ku (JP); Manabu Naito, Shinagawa-ku (JP); Hiroyuki Otsuka, Shinagawa-ku (JP)

(73) Assignee: SUMITOMO BAKELITE COMPANY LIMITED, Shinagawa-ku, Tokyo (JP)

(21) Appl. No.: 14/359,505

(22) PCT Filed: Nov. 6, 2012
(86) PCT No.: PCT/JP2012/078711

§ 371 Date: May 20, 2014

(30) Foreign Application Priority Data
Nov. 21, 2011 (JP) 2011-254321
Jan. 30, 2012 (JP) 2012-017200
Feb. 10, 2012 (JP) 2012-027800

(51) Int. Cl. C03C 25/28

(52) U.S. Cl. CPC C03C 25/285
USPC 442/64; 442/180

(57) ABSTRACT

A transparent composite substrate according to the present invention includes a composite layer containing a glass cloth formed of an assembly of glass fibers and a resin material impregnated in the glass cloth. The resin material has an Abbe number of equal to or larger than 45. The assembly of the glass fibers itself has a variation in a refractive index and a difference between a maximum value and a minimum value of the refractive index is equal to or less than 0.01. This makes it possible to provide a transparent composite substrate having superior optical characteristics and a high-reliable display element substrate using the transparent composite substrate. Further, the resin material preferably contains an alicyclic epoxy resin or an alicyclic acrylic resin as a major component thereof.

### BACKGROUND OF THE INVENTION

This invention relates to a transparent composite substrate and a display element substrate.

A glass substrate is widely used as a color filter for a display element such as a liquid display element and an organic EL display element; a display element substrate such as an active matrix substrate and a substrate for a solar battery. However, the glass substrate is easy to break, inflexible, unsuitable for weight reduction and the like. For the reasons stated above, various substrates formed of a plastic material (plastic substrates) are recently developed in substitution for the glass substrate.

As such a plastic substrate, a glass fiber composite resin sheet for a print substrate is known (for example, see patent document 1). The glass fiber composite resin sheet is obtained by impregnating a transparent resin into a glass cloth containing a glass fiber. Since the glass fiber composite resin sheet contains the glass fiber, it is possible to especially improve mechanical characteristics (bending strength, low liner expansion coefficient and the like) of the glass fiber composite resin sheet.

Recently, various attempts have been made for making the glass fiber composite resin sheet transparent in order to use the glass fiber composite resin sheet in substitution for the glass substrate.

However, conventional glass fiber composite resin sheets are optimized for use in the print substrate. Thus, there is a problem that the conventional glass fiber composite resin sheets have no optical characteristics being suitable for the above use application.

### RELATED ART DOCUMENT

### Patent Document

Patent document 1: JP H05-147979A

### SUMMARY OF THE INVENTION

It is an object of the present invention to provide a transparent composite substrate having superior optical characteristics and a high-reliable display element substrate using the transparent composite substrate.

The above object is achieved by the present invention which is specified in the following (1) to (14).

(1) A transparent composite substrate, comprising:

a composite layer containing a glass cloth formed of an assembly of glass fibers and a resin material impregnated in the glass cloth, the resin material having an Abbe number of equal to or larger than 45,

wherein the assembly of the glass fibers itself has a variation in a refractive index, and a difference between a maximum value and a minimum value of the refractive index is equal to or less than 0.01.

(2) The transparent composite substrate described in the above (1), wherein the resin material contains an alicyclic epoxy resin or an alicyclic acrylic resin as a major component thereof.

(3) The transparent composite substrate described in the above (1), wherein a water vapor permeation rate of the transparent composite substrate measured according to a method defined in “JIS K 7129 B” is equal to or less than 0.1 [g/m²/day/40° C., 90% RH].

(4) The transparent composite substrate described in the above (3), wherein an average coefficient of linear expansion of the transparent composite substrate at a temperature of 30 to 150° C. is equal to or less than 40 ppm/° C.

(5) The transparent composite substrate described in the above (1), further comprising a surface layer provided on at least one surface side of the composite layer and having at least transparency and gas barrier property.

(6) The transparent composite substrate described in the above (5), wherein the surface layer is formed of an inorganic material.

(7) The transparent composite substrate described in the above (6), wherein when a melting point of the inorganic material is defined as “Tm” [° C.] and a temperature at which a weight of a major component contained in the resin material decreases by 5% is defined as “Td” [° C.], “Tm” and “Td” satisfy a relationship of 1200<(Tm−Td)<1400.

(8) The transparent composite substrate described in the above (6), wherein the inorganic material contains a silicon compound.

(9) The transparent composite substrate described in the above (8), wherein the silicon compound is represented by a chemical formula of SiOₓN_{y}, and

wherein “x” and “y” in the chemical formula of SiOₓN_{y} respectively satisfy conditions of 1≦x≦2 and 0≦y≦1.

(10) The transparent composite substrate described in the above (8), wherein the silicon compound contains an oxygen atom and a nitrogen atom.

(11) The transparent composite substrate described in the above (10), wherein the silicon compound is represented by a chemical formula of SiOₓN_{y}, and

“x” and “y” in the chemical formula of SiOₓN_{y} satisfy conditions of y>0 and 0.3<x/(x+y)≦1.

(12) The transparent composite substrate described in the above (5), wherein an average thickness of the surface layer is in the range of 10 to 500 nm.

(13) The transparent composite substrate described in the above (5), further comprising an intermediate layer provided between the composite layer and the surface layer and formed of a resin material.

(14) A display element substrate having the transparent composite substrate defined by the above (1).

### Effect of the Invention

According to the present invention, it is possible to provide a transparent composite substrate having uniform and superior optical characteristics by using a resin material having a predetermined Abbe number and optimizing a refractive index of a glass cloth.

Further, according to the present invention, it is possible to provide a high-reliable display element substrate by using the mentioned transparent composite substrate.

### BRIEF DESCRIPTION OF THE DRAWINGS

FIG. 1 is a planar view showing a glass cloth of a transparent composite substrate according to one embodiment of the present invention.

FIG. 2 is a cross-sectional view showing the transparent composite substrate according to the embodiment of the present invention.

### DETAILED DESCRIPTION OF THE PREFERRED EMBODIMENT

Hereinafter, a transparent composite substrate and a display element substrate according to the present invention will be described in detail based on the preferred embodiments shown in the accompanying drawings.

The transparent composite substrate according to the present invention has a composite layer containing a glass cloth formed of an assembly of glass fibers and a resin material impregnated in the glass cloth. The resin material impregnated in the glass cloth has an Abbe number of equal to or larger than 45. In the transparent composite layer according to the present invention, the assembly of the glass fibers itself has a variation in a refractive index and a difference between a maximum value and a minimum value of the refractive index is equal to or less than 0.01.

In this specification, the word of “transparent” refers to a state having transparency. This state may has chromatic color, but the state is preferably colorless.

In the transparent composite layer according to the present invention, it is possible to keep uniform and superior optical characteristics of the transparent composite substrate by using a resin material having a predetermined Abbe number and optimizing a refractive index of the glass cloth.

<Transparent Composite Substrate>

Description will be first given to the transparent composite substrate according to the present invention.

FIG. 1 is a planar view showing the glass cloth of the transparent composite substrate according to one embodiment of the present invention. FIG. 2 is a cross-sectional view showing the transparent composite substrate according to the embodiment of the present invention.

A transparent composite substrate 1 shown in FIG. 2 has a composite layer 4 containing a glass cloth 2 and a resin material (matrix resin) 3 and gas barrier layers (surface layers) respectively provided on both surfaces of the composite layer 4 so as to cover the both surfaces of the composite layer 4. Hereinafter, description will be given to each component of the transparent composite substrate 1.

(Glass Cloth)

The glass cloth 2 is a woven cloth containing glass fibers (an assembly of glass fibers). Although examples of the glass cloth include an assembly of glass fibers obtained by simply bundling glass fibers and a non-woven cloth (an assembly of glass fibers), an exemplary case where the glass cloth 2 is the woven cloth is depicted in FIG. 1. The glass cloth 2 shown in FIG. 1 is constituted of vertical glass yarns (warp yarns) 2a and horizontal glass yarns (weft yarns) 2b. The vertical glass yarns 2a and the horizontal glass yarns 2b are substantially-perpendicular to each other. Examples of weave for the glass cloth 2 include plain weave shown in FIG. 1, basket weave, satin weave and twill weave.

Examples of an inorganic-based glass material forming the glass fiber include E glass, C glass, A glass, S glass, T glass, D glass, NE glass, quartz, a low-permittivity glass and a high-permittivity glass. Among them, the E glass, the S glass, the T glass or the NE glass is preferably used as the inorganic-based glass material because they contain less ionic impurities such as alkali metals and are easy to prepare. In particular, each of S-glass and T glass having an average coefficient of linear expansion equal to or less than 5 ppm/° C. at temperature of 30 to 250° C. is more preferably used.

Although a refractive index of the inorganic-based glass material is appropriately set depending on a refractive index of the resin material 3 to be used, the refractive index of the inorganic-based glass material is, for example, preferably in the range of about 1.4 to 1.6, and more preferably in the range of about 1.5 to 1.55. By setting the refractive index of the inorganic-based glass material to be within the above range, it is possible to provide the transparent composite substrate 1 having superior optical characteristics in a broader wavelength range.

An average size (width) of the glass fiber contained in the glass cloth 2 is preferably in the range of about 2 to 15 μm, more preferably in the range of about 3 to 12 μm, and even more preferably in the range of about 3 to 10 μm. By setting the average size of the glass fiber to be within the above range, it is possible to provide the transparent composite substrate 1 which can provide high surface smoothness and superior characteristics including mechanical characteristics and optical characteristics in good balance. In this regard, the average size of the glass fiber can be derived from an average size of the one hundred glass fibers measured from an observation image taken by observing a cross-sectional surface of the transparent composite substrate 1 with a variety of microscopes.

On the other hand, an average thickness of the glass cloth 2 is preferably in the range of about 10 to 300 μm, more preferably in the range of about 10 to 200 μm, and even more preferably in the range of about 20 to 120 μm. By setting the average thickness of the glass cloth 2 to be within the above range, it is possible to make the transparent composite substrate 1 thinner and suppress deterioration of mechanical characteristics of the transparent composite substrate 1 with ensuring sufficient flexibility and translucency.

In a case where the glass cloth is a glass woven cloth obtained by weaving bundles (glass yarns) formed of a plurality of glass fibers, the number of the glass fibers in the glass yarn is preferably in the range of 30 to 300, and more preferably in the range of 50 to 250. This makes it possible to provide the transparent composite substrate 1 which can provide high surface smoothness and superior characteristics including mechanical characteristics and optical characteristics in good balance.

Regarding such a glass cloth 2, it is preferred that a treatment for opening fiber is preliminarily carried out to the glass cloth 2. By carrying out the treatment for opening fiber, the glass yarns are widened. As a result, a cross-sectional surface of each of the glass yarns is formed into a flatten shape. Further, it is possible to make holes, which are called as basket holes, formed in the glass cloth 2 smaller. As a result, it is possible to improve smoothness of the glass cloth 2, thereby improving the surface smoothness of the transparent composite substrate 1. Examples of the treatment for opening fiber include a water-jet injection treatment, an air-jet injection treatment and a needle punching treatment.

Further, a coupling agent may be added to a surface of the glass fiber as necessary. Examples of the coupling agent include a silane-based coupling agent and a titanium-based coupling agent. Among them, the silane-based coupling agent is particularly preferably used. As the silane-based coupling agent, a silane-based coupling agent containing a functional group such as an epoxy group, a (meth)acryloyl group, a vinyl group, an isocyanate group and an amide group is preferably used.

A contained amount of the coupling agent is preferably in the range of about 0.01 to 5 parts by mass, more preferably in the range of about 0.02 to 1 parts by mass, and even more preferably in the range of about 0.02 to 0.5 parts by mass with respect to 100 parts by mass of the glass cloth. If the contained amount of the coupling agent is within the above range, it is possible to improve the optical characteristics of the transparent composite substrate 1. This makes it possible to provide the transparent composite substrate 1 being suitable for, for example, the display element substrate.

Although the glass cloth 2 itself has a variation in the refractive index, the glass cloth having a small variation in the refractive index is used. In more particular, the glass cloth having a difference between a maximum value and a minimum value of the refractive index equal to or less than 0.01 is used. By using the glass cloth 2 having such a refractive index distribution, it is possible to suppress light interference and the like due to a refractive index difference, thereby significantly improving the optical characteristics of the transparent substrate 1.

Further, it can be guessed that the refractive index distribution reflects a microstructure (atomic arrangement) in the glass fiber. Thus, it can be guessed that the glass cloth 2 having such a refractive index distribution also has uniformity of characteristics based on the microstructure (for example, weather resistance and the like). Namely, the optical characteristics of the glass cloth 2 as mentioned above can be uniformly changed even under environments in which time deterioration is inevitable. Thus, the transparent composite substrate 1 having such a glass cloth 2 can keep uniform and superior optical characteristics over the long term.

The difference between the maximum value and the minimum value of the refractive index in the glass cloth 2 is preferably equal to or less than 0.008, and more preferably equal to or less than 0.005.

A lower limit of the difference between the maximum value and the minimum value of the refractive index in the glass cloth 2 is not particularly limited to a specific value, but preferably equal to or more than 0.0001, and more preferably equal to or more than 0.0005. If the difference is within the above range, productivity of the glass cloth 2 is improved.

In a case where the glass cloth 2 used in the present invention is the glass woven cloth, when a second percentage of the glass fibers occupying in a cross section of the horizontal glass yarns (second glass fiber bundle) 2b per unit width is defined as “1”, a first percentage (relative value) of the glass fibers occupying in a cross section of the vertical glass yarns (first glass fiber bundle) 2a per unit width is preferably in the range of 1.04 to 1.40, more preferably in the range of 1.21 to 1.39, and even more preferably in the range of 1.25 to 1.35. By setting the above percentages to be within the above range, it is possible to make a coefficient of linear expansion in a vertical direction and a coefficient of linear expansion in a horizontal direction equal and more improve the optical characteristics of the transparent composite substrate 1.

In a case where the vertical glass yarns 2a and the horizontal glass yarns 2b are the same glass yarns with each other, namely, in a case where the first percentage is substantially equal to the second percentage, when the number of the horizontal glass yarns (second glass fiber bundles) per unit width is defined as “1”, a ratio (relative value) of the number of the vertical glass yarns (first glass fiber bundle) per unit width is preferably in the range of 1.02 to 1.18, more preferably in the range of 1.10 to 1.18, and even more preferably in the range of 1.12 to 1.16. By setting the ratio to be within the above range, it is possible to improve uniformity between the coefficient of linear expansion in the vertical direction and the coefficient of linear expansion in the horizontal direction and further improve the transparency of the transparent composite substrate 1.

Each of a twist number of the vertical glass yarns (first glass fiber bundle) 2a and a twist number of the horizontal glass yarns (second glass fiber bundle) 2b is preferably in the range of 0.2 to 2.0 per inch, and more preferably in the range of 0.3 to 1.6 per inch. By setting the twist numbers of the glass fiber bundles to be within the above range, it is possible to provide the transparent composite substrate 1 having a small haze value.

In a case where the glass cloth 2 is the glass woven cloth, the vertical glass yarns 2a are set so as to face toward a MD direction (flow direction) in a producing machine and the horizontal glass yarns 2b are set so as to face toward a TD direction (a direction perpendicular to the flow direction) at the time of producing the glass woven cloth. When the vertical glass yarns 2a and the horizontal glass yarns 2b are weaved, pressures added to the vertical glass yarns 2a and the horizontal glass yarns 2b are not identical to each other. Each of the pressures changes depending on a yarn-feeding direction. Thus, in the present invention, the pressures added to the vertical glass yarns 2a and the horizontal glass yarns 2b are adjusted so that the percentages of the glass fibers occupying in the cross section of the vertical glass yarns 2a and the horizontal glass yarns 2b (the first percentage and the second percentage) and the number of the glass yarns have anisotropy for optimizing the optical characteristics of the transparent composite substrate 1 with considering effects to the optical characteristics of the finally-obtained transparent composite substrate 1 caused by a difference of the pressures added at the time of weaving.

On the other hand, in a case where the glass cloth 2 has the anisotropy as mentioned above, a dimension change of the glass cloth 2, which is caused by changing of environments such as heat and humidity, also has anisotropy. In this case, there is a possibility that a deformation of the glass cloth 2 occurs depending on the type of the inorganic-based glass material, the type of the resin material 3 and the like. In order to address this problem, the present invention according to this embodiment can suppress the dimension change of the transparent composite substrate 1 by providing the gas barrier layer(s) 5 on the composite layer 4. This makes it possible to suppress uneven distribution of internal stress resulting in the dimension change of the transparent composite substrate 1.

This makes it possible to suppress deterioration of the optical characteristics and generations of curving, deformations or the like regardless of the type of the inorganic-based glass material, the type of the resin material 3 and the like. Namely, by providing the gas barrier layer(s) 5 on the composite layer 5, it is possible to solve potential problems which unavoidably occur in a case where the glass cloth 2 is the glass woven cloth.

In this regards, the above language “unit width” in this specification refers to one inch in a direction substantially perpendicular to a longitudinal direction (lengthwise direction) of the glass fiber bundle.

(Resin Material)

The cured resin material 3 used in the present invention has an Abbe number of equal to or larger than 45, and more preferably equal to or larger than 48.

The “Abbe number (ν_{d})” here indicates wavelength dependency of refractive index, that is, a degree of dispersion (variation of refractive index with respect to wavelength). The Abbe number can be obtained from the expression of ν_{d}=(n_{D}−1)/(n_{F}−n_{C}). “n_{D}”, “n_{F}” and “n_{C}” in the expression respectively represent refractive indexes with respect to the Fraunhofer C (wavelength is 656 nm), D (wavelength is 589 nm) and F (wavelength is 486 nm) lines. Thus, a refractive index of the resin material 3 having a small Abbe number significantly changes depending on wavelength.

Common glass fibers have an Abbe number of equal to or larger than 50. Thus, in a case where a resin material to be used together with such glass fibers has a small Abbe number (in particular, smaller than 45), even if a refractive index of the resin material at wavelength of 589 nm is adjusted so as to be equal to a refractive index of the glass fibers at wavelength of 589 nm, a refractive index of the resin material at wavelength of equal to or shorter than 400 nm is significantly different from a refractive index of the glass fibers at wavelength of 400 nm. As a result, a light transmittance at wavelength of equal to or shorter than 400 nm of a transparent composite substrate using such a resin material with the common glass fibers reduces.

On the other hand, in the present invention, by using the resin material 3 having the Abbe number of equal to or larger than 45, it is possible to make a refractive index of the resin material equal to a refractive index of the common glass fibers over a board wavelength range. As a result, the transparent composite substrate 1 according to the present invention has superior light transmittance with respect to light having a wavelength of, for example, equal to or shorter than 400 nm as well as other wavelengths. Namely, the transparent composite substrate according to the present invention has uniform and superior optical characteristics over a board wavelength range.

In addition, in a case where the resin material 3 has an Abbe number of smaller than 45, a difference between the Abbe number of the resin material 3 and the Abbe number of a glass forming the glass fibers becomes larger when the Abbe number of the resin material 3 changes due to effects of moisture absorption and oxidation of the resin material 3. As a result, a haze value of the transparent composite substrate 1 becomes large. On the other hand, in a case where the resin material 3 has an Abbe number of equal to or larger than 45, the difference between the Abbe number of the resin material 3 and the Abbe number of a glass material forming the glass fibers is small even if the Abbe number of the resin material changes. Thus, a change amount of haze is also small. In particular, in a case of providing the gas barrier(s) on the composite layer 4, an effect that suppresses changing of haze of the transparent composite substrate 1 becomes more remarkable.

Examples of the resin material 3 used in the present invention include an epoxy-based resin, an oxetane-based resin, an isocyanate-based resin, an acrylate-based resin, an olefin-based resin, a cycloolefin-based resin, a diallyl phthalate-based resin, a polycarbonate-based resin, a diallyl carbonate-based resin, an urethane-based resin, a melamine-based resin, a polyimide-based resin, an aromatic polyamide-based resin, a polystyrene-based resin, a polyphenylene-based resin, a polysulfone-based resin, a polyphenyleneoxide-based resin and a silsesquioxane-based compound. Among them, an epoxy resin or an acrylic resin (in particular, an alicyclic epoxy resin or an alicyclic acrylic resin) is preferably used as the resin material 3.

Examples of the epoxy resin used in the present invention include a bisphenol-A-type epoxy resin, a bisphenol-F-type epoxy resin, a bisphenol-S-type epoxy resin, a hydrogenated material of one of the above resins, an epoxy resin having a dicyclopentadiene structure, an epoxy resin having a triglycidyl isocyanurate structure, an epoxy resin having a cardo structure, an epoxy resin having a polysiloxane structure, an alicyclic polyfunctional epoxy resin, an alicyclic epoxy resin having a hydrogenated biphenylene structure, an alicyclic epoxy resin having a hydrogenated bisphenol-A structure and a combination of one or more of the above epoxy resins.

The above-mentioned epoxy resins can be roughly classified into a glycidyl ether-type epoxy resin having a glycidyl group and an ether bonding, a glycidyl ester-type epoxy resin having a glycidyl group and an ester bonding, a glycidyl-type epoxy resin such as a glycidyl amine-type epoxy resin having a glycidyl group and an amino group and an alicyclic epoxy resin having an alicyclic epoxy group. Among them, the alicyclic epoxy resin having the alicyclic epoxy group is preferably used as the epoxy resin. In more particular, the resin material 3 containing the alicyclic epoxy resin such as an alicyclic polyfunctional epoxy resin, an alicyclic epoxy resin having a hydrogenated bisphenyl structure and an alicyclic epoxy resin having a hydrogenated bisphenol-A structure as a major component thereof is used.

Concrete examples of such an alicyclic epoxy resin include 3,4-epoxycyclohexylmethyl-3′; 4′-epoxycyclohexenecarboxylate; 3,4-epoxy-6-methylcyclohexylmethyl-3; 4-epoxy-6-methylcyclohexanecarboxylate; 2-(3,4-epoxy)cyclohexyl-5,5-spiro-(3,4-epoxy)cyclohexane-m-dioxane; 1,2:8,9-diepoxylimonene; dicyclopentadienedioxide; cyclooctenedioxide; acetaldiepoxide; vinylcyclohexanedioxide; vinylcyclohexenemonooxide 1,2-epoxy-4-vinylcyclohexane; bis(3,4-epoxycyclohexylmethyl)adipate; bis(3,4-epoxy-6-methylcyclohexylmethyl)ajipate; exo-exobis(2,3-epoxycyclopentyl)ether; 2,2-bis(4-(2,3-epoxypropyl)cyclohexyl)pronane; 2,6-bis(2,3-epoxypropoxycyclohexyl-p-dioxyane); 2,6-bis(2,3-epoxypropoxy)norbornene, diglycidylether of linoleic acid dimer; limonenedioxide; 2-2-bis(3,4-epoxycyclohexyl)propane; o-(2,3-epoxy)cyclopentylphenyl-2,3-epoxypropylether; 1,2-bis[5-(1,2-epoxy)-4,7-hexahydromethanoinedanxyl]ethane; cyclohexanedioldiglycidylether; diglycidylhexahydrophtalate; ε-caprolactoneoligomer in which 3,4-epoxycyclohexylmetanol and 3,4-epoxycyclohexylcarbon acid are respectively bonded to both ends of the ε-caprolactoneoligomer through an ester-bonding; epoxydized hexahydrobenzilalcohol and a combination of one or more of the above alicyclic epoxy resins.

Especially, an alicyclic epoxy resin having one or more epoxycyclohexane rings in a molecular is preferably used as the alicyclic epoxy resin. Among them, as a composition having the two epoxycyclohexane rings in a molecular, alicyclic epoxy structures represented by the following chemical formulas (1), (2) and (3) are preferably used.

[chemical structure]

wherein in the chemical formula (2), “—X—” represents any one of “—O—”, “—S—”, “—SO—”, “—SO₂—”, “—CH₂—”, “—CH(CH₃)—” and “—C(CH₃)₂—”.

[chemical structure]

On the other hand, as an alicyclic epoxy resin having the one epoxycyclohexane ring in a molecular, alicyclic epoxy resins represented by the following chemical formulas (4) and (5) are preferably used.

[chemical structure]

Since such an alicyclic epoxy resin has superior hardenability at low temperature, it is possible to carry out a curing treatment thereof at low temperature. This makes it unnecessary to heat the resin material 3 to high temperature for obtaining a cured material, thereby suppressing variation of temperature in the cured material at the time of cooling the cured material to the room temperature after obtaining the cured material from the resin material 3. As a result, it is possible to provide the transparent composite substrate 1 having superior optical characteristics.

Further, since such a cured alicyclic epoxy resin has a small coefficient of linear expansion, interfacial stress at an interfacial surface between the glass cloth 2 and the resin material 3 in the transparent composite substrate 1 obtained by using the resin material 3 containing such an alicyclic epoxy resin becomes significantly small at room temperature. Thus, it is possible to provide the transparent composite substrate 1 having the small interfacial stress. Further, optical anisotropy of the transparent composite substrate 1 also becomes small. Furthermore, it is possible to prevent deformations such as curving and wave undulations of the transparent composite substrate 1 because the coefficient of linear expansion of the transparent composite substrate 1 becomes small.

In addition, since such an alicyclic epoxy resin has superior transparency and heat resistance, the alicyclic epoxy resin can contribute to provide the transparent composite substrate 1 having superior optical transparency and heat resistance.

The resin material 3 preferably contains the alicyclic epoxy resin or the alicyclic acrylic resin as a major component thereof. The language of “major component” in this specification refers to a component accounting for more than 50 percent by mass of the resin material 3. An amount of the alicyclic epoxy resin contained in the resin material 3 is preferably equal to or more than 70 percent by mass, and more preferably equal to or more than 80 percent by mass.

As the resin material 3, a glycidyl-type epoxy resin is preferably used together with the alicyclic epoxy resin. By using these resins in combination, it is possible to easily adjust the refractive index of the resin material 3 with suppressing the deterioration of the optical characteristics of the transparent composite substrate 1. Namely, by appropriately adjusting a mixing ratio of the alicyclic epoxy resin and the glycidyl-type epoxy resin, it is possible to set the refractive index of the resin material 3 to be a desired value. As a result, it is possible to provide the transparent composite substrate 1 having superior optical transparency.

In this case, an additive amount of the glycidyl-type epoxy resin is preferably in the range of about 0.1 to 10 parts by mass, and more preferably in the range of about 1 to 5 parts by mass with respect to 100 parts by mass of the alicyclic epoxy resin.

Examples of the glycidyl-type epoxy resin include a glycidyl ether-type epoxy resin, a glycidyl ester-type epoxy resin and a glycidyl amine-type epoxy resin.

As the glycidyl-type epoxy resin, a glycidyl-type epoxy resin having a cardo structure is preferably used. Namely, by adding the glycidyl-type epoxy resin having the carbo structure to the alicyclic epoxy resin and then using the combination thereof, it is possible to improve the optical characteristics and the heat resistance of the transparent composite substrate 1 because a plurality of aromatic rings derived from a bisarylfluoren structure are contained in the cured resin material 3.

Examples of such a glycidyl-type epoxy resin having the carbo structure include “On Court EX series” (made by NAGASE & Co., Ltd.) and “OGSOL” (made by Osaka Gas Chemicals Co., Ltd.).

Further, as the resin material 3, a silsesquioxane-based compound is preferably used together with the alicyclic epoxy resin. Especially, a silsesquioxane-based compound having a photopolymerizable group such as an oxetanyl group and a (meth)acryloyl group is more preferably used. By using these resins in combination, it is possible to easily adjust the refractive index of the resin material 3 with suppressing the deterioration of the optical characteristics of the transparent composite substrate 1. Further, since the silsesquioxane-based compound having the oxetanyl group has high compatibility with respect to the alicyclic epoxy resin, it is possible to uniformly mix these resins. As a result, it is possible to more reliably adjust a refractive index of the composite layer 4 and provide the transparent composite substrate 1 having superior optical characteristics.

Examples of such a silsesquioxane-based compound having the oxetanyl group include “OX-SQ”, “OX-SQ-H” and “OX-SQ-F” which are made by TOAGOSEI Co., Ltd.

In this case, an additive amount of the silsesquioxane-based compound is preferably in the range of about 1 to 20 parts by mass, and more preferably in the range of about 2 to 15 parts by mass with respect to 100 parts by mass of the alicyclic epoxy resin.

On the other hand, examples of the alicyclic acrylic resin include tricyclodecanyl acrylate, a hydrogenated material thereof, dicyclopentanyl diacrylate, isobornyl diacrylate, hydrogenated bisphenol-A diacrylate and cyclohexane-1,4-dimetanoldiacrylate. In more particular, “OPTOREZ series” made by Hitachi Chemical Co., Ltd., an acrylate monomer made by DAICEL-CYTEC Ltd. or the like is used as the alicyclic epoxy resin.

Furthermore, glass-transition temperature of the resin material 3 used in the present invention is preferably equal to or higher than 150° C., more preferably equal to or higher than 170° C., and even more preferably equal to or higher than 180° C. By setting the glass-transition temperature of the resin material 3 to satisfy the above condition, it is possible to prevent the generations of the curving and the deformations of the transparent composition substrate 1 even if various heat treatments are carried out to the transparent composite substrate 1 at the time of processing a display element substrate using the transparent composite substrate 1 after the transparent composite substrate 1 is produced.

Furthermore, a heat distortion temperature of the resin material 3 is preferably equal to or higher than 200° C. and a coefficient of thermal expansion of the resin material 3 is preferably equal to or less than 100 ppm/K.

The refractive index of the resin material 3 is preferably close to an average refractive index of the glass cloth 2 as possible, more preferably substantially identical to the average refractive index of the glass cloth 2. In particular, a refractive difference between the refractive index of the resin material 3 and the average refractive index of the glass cloth 2 is preferably equal to or less than 0.01, and more preferably equal to or less than 0.005. By setting the refractive difference to satisfy the above condition, it is possible to provide the transparent composite substrate 1 having superior optical transparency.

(Other Components)

In the transparent composite substrate 1, the resin material 3 may contain a material such as filler other than the above-mentioned components.

Examples of the filler include glass filler constituted of fiber fragments, particles of an inorganic-based glass material or the like. By dispersing the glass filler in the resin material 3, it is possible to improve mechanical strength of the transparent composite substrate 1 without deterioration of the optical transparency of the transparent composite substrate 1.

Concrete examples of the glass filler include a glass chopped strand, a glass bead, a glass flake, glass powder and a milled glass.

As the inorganic-based glass material, a material having the same components as the above-mentioned glass cloth is used.

An amount of the filler contained in the resin material 3 is preferably in the range of about 1 to 90 parts by mass, and more preferably in the range of about 3 to 70 parts by mass with respect to 100 parts by mass of the glass cloth.

A size (diameter) of the filler is preferably equal to or smaller than 100 nm. Since the filler satisfying the above condition is not likely to scatter at the interfacial surface, it is possible to keep the transparency of the transparent composite substrate 1 relatively high even if the filler disperses in the resin material 3 in large quantities.

Further, the above-mentioned coupling agent may be added into the resin material 3. This makes it possible to relax concentration of the above-mentioned stress, thereby further improving the optical characteristics of the transparent composite substrate 1. In a case where the coupling agent is added into the resin material 3, an additive amount of the coupling agent is preferably in the range of about 0.01 to 5 parts by mass, and more preferably in the range of about 0.05 to 2 parts by mass with respect to 100 parts by mass of the resin material 3.

(Gas Barrier Layer)

The gas barrier layer(s) 5 having transparency and gas barrier property is (are) provided on the composite layer 4. By providing the gas barrier layer(s) 5 on the composite layer 4, it is possible to suppress or prevent that gas such as oxygen and water vapor in the atmosphere reaches to the glass cloth 2. Thus, it is possible to prevent the refractive index of the glass cloth 2 from being non-uniform due to negative effects caused by long-term actions of such gas. As a result, time deterioration of the optical characteristics of the transparent composite substrate 1 is prevented. Namely, it is possible to provide the transparent composite substrate 1 which can keep superior optical characteristics over the long term.

Further, by providing the gas barrier layer(s) 5 on the composite layer 4, it is also possible to suppress the dimension change of the glass cloth 2 itself due to moisture absorption. Thus, it is possible to keep uniformity of the optical characteristics of the glass cloth 2 even under harsh environments. In addition, it is possible to more reliably prevent the anisotropy of the dimension change in the glass cloth 2 from generating as mentioned above.

A constituent material for the gas barrier layer 5 is not particularly limited to a specific material and may be either an organic material or an inorganic material, but is preferably the inorganic material. Examples of the inorganic material for the gas barrier layer 5 include an oxide of one material selected from the group consisting of Si, Al, Ca, Na, B, Ti, Pb, Nb, Mg, P, Ba, Ge, Li, K and Zr; an oxide of mixed material of two or more of the above materials; a fluoride; a nitride and an oxynitride of the above materials.

It is preferred that the above inorganic material contains several types of the oxides of the above materials, and it is more preferred that the inorganic material is constituted of a glass material containing several types of the oxides. By using such a constituent material for the gas barrier layer 5, it is possible to improve the gas barrier property of the gas barrier layer 5 due to a layer constituted of the glass material which is amorphous and dense.

As the oxide contained in the inorganic material, silicon oxide, aluminum oxide, magnesium oxide or boric oxide is preferably used. Among them, the silicon oxide which is a silicon compound is particularly preferably used. By using the inorganic material containing the silicon oxide, it is possible to significantly improve the gas barrier property of the gas barrier layer 5. In addition, since the silicon oxide has high transparency, the silicon oxide is preferably used from the viewpoint of the transparency. The silicon oxide refers to a silicon compound (mentioned below) represented by a chemical formula of SiOₓN_{y} wherein “x” satisfies the condition of 1≦x≦2 and “y” is equal to zero.

The inorganic material preferably contains silicon nitride in addition to the silicon oxide (hereinafter, a material containing both of the silicon oxide and the silicon nitride is referred to as “silicon oxynitride”). By using the inorganic material containing the silicon oxynitride, it is possible to allow the gas barrier layer 5 to have superior surface hardness and superior gas barrier property. Namely, such a gas barrier layer 5 can provide the superior gas barrier property and superior protection property in good balance. Further, since the silicon oxynitride has high transparency, the silicon oxynitride is preferably used from the viewpoint of the transparency.

The silicon oxynitride is a silicon compound represented by a chemical formula of SiOₓN_{y}. “x” and “y” in the chemical formula preferably satisfy conditions of 1≦x≦2 and 0<y≦1, and more preferably satisfy conditions of 1.2≦x≦1.8 and 0.2≦y≦0.8. The gas barrier layer 5 formed of the silicon oxynitride satisfying the above conditions can provide superior gas barrier property and superior protection property in good balance and contribute to improve the optical transparency of the transparent composite substrate 1 because a refractive index of the gas barrier layer 5 is optimized with respect to the composite layer 4.

If “x” is lower than the above lower limit, optical transparency and flexibility of the gas barrier layer 5 reduces. In particular, if “x” is equal to zero (that is a case where the silicon compound is silicon nitride), there is a possibility that the gas barrier property of the gas barrier layer 5 reduces depending on an average thickness of the gas barrier layer 5 and the like. On the other hand, if “x” is larger than the above upper limit, there is a possibility that the surface protection property of the gas barrier layer 5 reduces depending on a value of “y” and the like. If “y” is larger than the above upper limit, there is a possibility that the surface protection property of the gas barrier layer 5 reduces.

In the silicon compound, “x” and “y” preferably satisfy conditions of y>0 and 0.3<x/(x+y)≦1, more preferably satisfy conditions of y>0 and 0.35<x/(x+y)≦0.95, and even more preferably satisfy conditions of y>0 and 0.4<x/(x+y)≦0.9.

The gas barrier layer 5 formed of the silicon compound satisfying the above conditions can provide superior gas barrier property and superior surface protection property in good balance. Thus, it is possible to suppress moisture absorption and oxidization of the composite layer 4, thereby keeping uniformity of the optical characteristics of the transparent composite substrate 1 over the long term. Further, it is possible to reliably protect a surface of the transparent composite substrate 1 from damage. As a result, the transparent composite substrate 1 being capable of withstanding under harsh environments over the long term can be obtained because abrasion resistance of the transparent composite substrate 1 is improved.

Further, by providing the gas barrier layer(s) 5 formed of the silicon compound, a coefficient of linear expansion of the gas barrier layer(s) 5 is optimized with respect to the composite layer 4. Thus, it is possible to suppress the deformations such as curving and wave undulations of the transparent composite substrate 1 with adding the gas barrier property to the gas barrier layer 5. As a result, it is possible to make the optical characteristics of the transparent composite substrate 1 more uniform. Further, it is possible to improve the optical transparency of the transparent composite substrate 1 because the refractive index of the gas barrier layer 5 becomes close to that of the composite layer 4.

In addition, the gas barrier layer 5 formed of the silicon compound has functions of suppressing the moisture absorption and the oxidization of the composite layer 4 as mentioned above, and further suppressing the change of the Abbe number of the resin material 3. Thus, the resin material can keep a large Abbe number even if the transparent composite substrate 1 is used under harsh environments. Therefore, it is possible to provide the transparent composite substrate 1 having uniform and superior optical characteristics over a board wavelength range even if the transparent composite substrate 1 is used under harsh environments.

If “x/(x+y)” is lower than the above lower limit, there is a possibility that optical transparency and flexibility of the gas barrier layer 5 reduce because an abundance ratio of oxygen atoms with respect to nitrogen atoms significantly reduces. Further, there is a possibility that the board wavelength rage in which the uniform and superior optical characteristics can be provided becomes narrower because a difference between the Abbe numbers of the gas barrier layer 5 and the resin material 3 becomes too large.

In this regard, when a melting point of the inorganic material is defined as “Tm” [° C.] and a temperature at which a weight of the major component contained in the resin material 3 decreases by 5% is defined as “Td” [° C.] (hereinafter, referred to as “5% weight decreasing temperature Td”), “Tm” and “Td” preferably satisfy a relationship of 1200<(Tm−Td)<1400, more preferably satisfy a relationship of 1250<(Tm−Td)<1400, and even more preferably satisfy a relationship of 1300<(Tm−Td)<1400.

The transparent composite substrate 1 satisfying the above relationship has superior gas barrier property and surface protection property because characteristics between the inorganic material and the resin material 3 are optimized. Thus, it is possible to suppress moisture absorption, oxidization, curving, deformations and the like of the transparent composite substrate 1, thereby keeping the optical characteristics of the transparent composite substrate 1 uniform over the long term and reliably preventing the surface of the transparent composite layer 5 from being damaged.

Although the reasons why the above advantageous results can be provided by setting “Tm” and “Td” to satisfy the above relationship are not clear, it can be guessed that physical properties such as the melting point and the 5% weight decreasing temperature “Td” serve as indicators which reflects effects of complex microstructures in each material as a whole and various problems which may be caused in the transparent composite substrate 1 are closely linked with the effects of the microstructures. Thus, it is possible to interpret that one of the reasons results from the above-guessed relationships.

The 5% weight decreasing temperature “Td” [° C.] can be measured as temperature at which the major component contained in the resin material 3 decreases by 5% due to heating in the atmosphere with, for example, a thermogracimetric analysis (TGA). On the other hand, if the major component contained in the resin material 3 has no melting point and the major component is thermally decomposed by heating, a starting point of thermal decomposition may be defined as the above “Tm” [° C.].

The average thickness of the gas barrier layer 5 is not particularly limited to a specific value, but is preferably in the range of about 10 to 500 nm. If the average thickness of the gas barrier layer 5 is within the above range, it is possible to provide the gas barrier layer 5 having sufficient gas barrier property and protection property as well as superior flexibility.

The gas barrier layer 5 preferably has a water vapor permeation rate defined in “JIS K 7129 B” being equal to or less than 0.1 [g/m²/day/40° C., 90% RH]. By using the gas barrier layer 5 having the water vapor permeation rate satisfying the above condition, it is possible to suppress alterations and deteriorations of the glass cloth 2 and the resin material 3 and changing of the refractive index caused by the alteration and the deterioration, thereby providing the transparent composite substrate 1 having superior optical characteristics over the long term.

Further, the gas barrier layer 5 preferably has an oxygen permeation rate defined in “JIS K 7126 B” being equal to or less than 0.1 [cm³/m²/day/1 atm/23° C.]. By using the gas barrier layer 5 having the oxygen permeation rate satisfying the above condition, it is possible to suppress alteration and deterioration of the resin material 3 due to oxidization and changing of the refractive index caused by the alteration and the deterioration, thereby providing the transparent composite substrate 1 having superior optical characteristics over the long term.

It is also noted that an intermediate layer may be provided between the composite layer 4 and the gas barrier layer 5 as necessary. Although functional layers described later and the like may be used as the intermediate layer, a layer formed of a resin material such as an epoxy resin and an acrylic resin is particularly preferably used. By providing such an intermediate layer between the composite layer 4 and the gas barrier layer 5, it is possible to improve flatness and smoothness of the surface of the transparent composite substrate 1, thereby improving the optical characteristics of the transparent composite substrate 1. Simultaneously, it is possible to improve adhesion between the composite layer 5 and the gas barrier layer 5, thereby reliably preventing the gas barrier layer 5 from separating from the composite layer 4. As a result, endurance of the transparent composite layer 1 is improved, thereby providing the transparent composite substrate 1 which can keep uniform and superior optical characteristics over the long term.

As a constituent material for the intermediate layer, a similar material to the resin material 3 contained in the composite layer 4 may be used. Especially, a material having the same components as the resin material 3 contained in the composite layer 4 is preferably used. This makes it possible to allow the intermediate layer to be hard to separate, thereby more improving the adhesion between the composite layer 4 and the gas barrier layer 5.

The gas barrier layer (surface layer) 5 may further has other functions, as long as it has at least transparency and gas barrier property.

(Characteristics of Transparent Composite Substrate)

A total light transmittance at 400 nm wavelength of the transparent composite substrate 1 described above is preferably equal to or more than 70%, more preferably equal to or more than 75%, and even more preferably equal to or more than 78%. If the total light transmittance at 400 nm wavelength is less than the above lower limit, there is a possibility that display performance of the display element using the transparent composite substrate 1 becomes insufficient.

Further, an average thickness of the transparent composite substrate 1 is not particularly limited to a specific value, but is preferably in the range of about 40 to 200 μm, and more preferably in the range of 50 to 100 μm.

Further, an average coefficient of linear expansion at temperature of 30 to 150° C. of the transparent composite substrate 1 is preferably equal to or less than 40 ppm/° C., more preferably equal to or less than 20 ppm/° C., even more preferably equal to or less than 15 ppm/° C., and further even more preferably equal to or less than 10 ppm/° C. Since a dimension change due to temperature change in the transparent composite substrate 1 having the average coefficient of linear expansion satisfying the above condition is sufficiently small, it is possible to suppress deterioration of the optical characteristics due to the dimension change. It is noted that the language of “deterioration of the optical characteristics due to the dimension change” refers to, for example, separation of the resin material 3 from the glass cloth 2. This separation may result in increasing of the haze value.

Thus, the obtained transparent composite substrate 1 can keep uniform and superior optical characteristics over a wide temperature range and over the long term. Further, by using the transparent composite substrate 1 having the average coefficient of linear expansion satisfying the above condition for a substrate for an active matrix display element or the like, it is possible to allow various problems such as curving and breaking of wire to become hard to occur.

Further, the transparent composite substrate 1 preferably has water vapor permeation rate defined in “JIS K 7129 B” being equal to or less than 0.1 [g/m²/day/40° C., 90% RH]. By using the transparent composite substrate 1 having the water vapor permeation rate satisfying the above condition, it is possible to reduce an amount of water vapor passing through an inside of the transparent composite substrate 1, thereby suppressing moisture absorption of the glass cloth 2 or the resin material 3. As a result, it is possible to suppress degeneration and deterioration of the resin material 3, thereby especially suppressing the changing of the Abbe number of the resin material 3. Thus, since the resin material 3 can keep a large Abbe number, it is possible to provide the transparent composite substrate 1 having uniform and superior optical characteristics over a board wavelength range even if the transparent composite substrate 1 is used under harsh environments.

As mentioned above, the refractive difference between the maximum value and the minimum value of the refractive index of the glass cloth 2 is small (equal to or less than 0.01) and the microstructure of the glass cloth 2 is uniform. Thus, a variation in the refractive index of the glass cloth 2 (composite layer 4) also becomes uniform, thereby providing the transparent composite layer 1 which can keep uniform and superior optical characteristics over the long term.

Further, if the water vapor permeation rate satisfies the above condition, it is possible to suppress a variation in the coefficient of linear expansion of the transparent composite substrate 1 due to the moisture absorption. Thus, it is also possible to reliably suppress the deterioration of the optical characteristics of the transparent composite substrate 1 due to the dimension change. In addition, if the water vapor permeation rate satisfies the above condition, it is possible to suppress deterioration of the display element using the transparent composite substrate 1 due to the moisture absorption by using the transparent composite substrate 1 as a display element substrate. As a result, it is possible to keep high reliability of the display element over the long term.

Further, the transparent composite substrate 1 preferably has oxygen permeation rate defined in “JIS K 7126 B” being equal to or less than 0.1 [cm³/m²/day/1 atm/23° C.]. By using the transparent composite substrate 1 having the oxygen permeation rate satisfying the above condition as the display element substrate, it is possible to suppress deterioration of the display element due to oxidization, thereby keeping high reliability of the display element over the long term.

For the reasons explained above, according to the present invention, it is possible to provide the transparent composite substrate 1 which can keep uniform and superior optical characteristics over the long term.

<Display Element Substrate>

The transparent composite substrate 1 can be applied to various substrates (the display element substrate according to the present invention) such as a substrate for a liquid crystal display element, a substrate for an organic EL element, a substrate for a color filter, a substrate for a thin film transistor (TFT) element, a substrate for an electronic paper and a substrate for a touch screen. In addition, the transparent composite substrate 1 can be applied to a substrate for a solar cell and the like.

The display element substrate according to the present invention has the transparent composite substrate 1. Further, the display element substrate may have the functional layer formed on the surface of the transparent composite substrate 1 as necessary.

Examples of such a functional layer include a transparent conductive layer formed of indium oxide, tin oxide, an oxide of a tin-indium alloy or the like; a metallic conductive layer formed of gold, silver, palladium, an alloy of these metallic materials or the like; a smooth layer formed of an epoxy resin, an acrylic resin or the like and a shock absorbing layer formed of an elastomeric or gel-like silicone curing material, polyurethane, an epoxy resin, an acrylic resin, polyethylene, polypropylene, polystyrene, a vinyl chloride resin, a polyamide resin, a polycarbonate resin, a polyacetal resin, polyethersulfone, polysulfone or the like.

Among them, it is preferred that the smooth layer has heat resistance, transparency and chemical resistance. As a constituent material for the smooth layer, for example, a material having the same components as the resin material 3 contained in the composite layer 4 is preferably used. An average thickness of the smooth layer is preferably in the range of about 0.1 to 30 μm, and more preferably in the range of 0.5 to 30 μm.

Further, examples of a layer construction include a construction having the smooth layer provided on at least one surface side of the transparent composite layer 1 and the shock absorbing layer provided on the smooth layer and a construction having the shock absorbing layer provided on at least one surface side of the transparent composite layer 1 and the smooth layer provided on the shock absorbing layer.

As mentioned above, the display element substrate according to the present invention essentially has more superior shock resistance than a glass substrate. By further providing the shock absorbing layer explained above, it is possible to more improve the shock resistance.

According to the present invention described above, it is possible to provide the display element substrate which can provide the display element having high reliability and high quality.

<Method for Producing Transparent Composite Substrate>

As mentioned above, the transparent composite substrate 1 is obtained by impregnating the uncured resin material 3 into the glass cloth 2, molding (forming) it in this state into a plate-like shape and then curing the resin material 3.

In particular, the transparent composite substrate 1 is obtained through steps including preparing the composite layer 4 by impregnating a resin varnish into a glass cloth and then curing the resin varnish with molding (forming) and forming the gas barrier layer(s) 5 on the composite layer 4 so as to cover the surface of the composite layer 4. Hereinafter, detailed description will be given to a method for producing.

[1] First, a surface treatment is carried out by adding a coupling agent to the glass cloth 2. For example, this addition of the coupling agent is carried out with a method including dipping the glass cloth 2 into liquid containing the coupling agent, a method including coating the glass cloth 2 with the above liquid, a method including spraying the above liquid on the glass cloth 2 or the like. In this regard, this process is carried out as necessary, but may be omitted.

[2] Next, the resin varnish is prepared. The resin varnish contains the above-mentioned uncured resin material 3 and other components such as filler, organic solvent and the like. Further, the resin varnish may contain a curing agent, an antioxidant, a flame retardant, an ultraviolet absorbing agent and the like as necessary.

(Curing Agent)

Examples of the curing agent include a cross-linking agent such as an acid anhydride and an aliphatic amine; a cation-based curing agent; an anion-based curing agent and a combination of one or more of these curing agents.

Among them, the cation-based curing agent is particularly preferably used as the curing agent. By using the cation-based curing agent, it is possible to cure the resin material at relatively low temperature. Thus, it becomes unnecessary to heat the resin varnish to high temperature at the time of curing, thereby suppressing generation of thermal stress caused by temperature change at the time of cooling a cured material of the resin material 3 to the ordinary temperature (room temperature). As a result, it is possible to provide the transparent composite substrate 1 having low optical anisotropy.

Further, by using the cation-based curing agent, it is possible to provide the transparent composite substrate 1 having high heat resistance (for example, glass-transition temperature). It can be guessed that this results from increasing of cross-linking density of the cured material of the resin material 3 (for example, an epoxy resin) caused by using the cation-based curing agent.

Examples of the cation-based curing agent include a curing agent which can emit a material for initiating a cation polymerization by heat such as an onium salt-based cationic curing agent and an aluminum chelate-based cationic curing agent; and a curing agent which can emit a material for initiating a cationic polymerization due to irradiation of an active energy ray such as an onium salt-based cation-based curing agent. Among them, an optical cation-based curing agent is preferably used as the cation-based curing agent. By using such a curing agent, it is possible to easily select whether or not to cure the resin material 3 by only selecting an irradiated area of light.

Any material may be used as the optical cation-based curing agent, as long as it can initiate reactions of a multifunctional cationic polymerizable composition and a monofunctional cationic polymerizable composition with the optical cationic polymerization. Examples of the optical cation-based curing include an onium salt such as a diazonium salt of a Lewis acid, an iodonium salt of a Lewis acid and a sulfonium salt of a Lewis acid. Concrete examples of the optical cation-based curing agent include phenyldiazonium salt of boron tetrafluoride, diphenyliodonium salt of phosphorus hexafluoride, diphenyliodonium salt of antimonious hexafluoride, tri-4-methylphenylsulfonium salt of aresenic hexafluoride and tri-4-methylphenylsulfonium salt of antimonious tetrafluoride.

Further, an optical radical curing agent such as “IRGACURE series” (made by Ciba-Japan Corporation) may be used depending on the type of the resin material 3 (resin monomer).

On the other hand, examples of a thermal cation-based curing agent include an aromatic sulfonium salt, an aromatic iodonium salt, an ammonium salt, an ammonium chelate and a boron trifluoride amine complex.

An amount of such a cation-based curing agent contained in the resin material 3 is not particularly limited to a specific value, but is preferably in the range of about 0.1 to 5 parts by mass, and more preferably in the range of 0.5 to 3 parts by mass with respect to 100 parts by mass of the resin material 3 (for example, an alicyclic epoxy resin). If the amount of the cation-based curing agent contained in the resin material 3 is less than the above lower limit, there is a case where hardenability of the resin material 3 reduces. On the other hand, if the amount of the cation-based curing agent contained in the resin material 3 is larger than the above upper limit, there is a case where the transparent composite substrate 1 becomes brittle.

In a case of curing the resin material 3 with light, a sensitizer, an acid proliferative agent and the like may be used for facilitating the curing reaction of the resin material 3 as necessary.

(Antioxidant)

Examples of the antioxidant include a phenol-based antioxidant, a phosphorus-based antioxidant and a sulfur-based antioxidant. Especially, a hindered phenol-based antioxidant is preferably used.

Examples of the hindered phenol-based antioxidant include BHT and 2,2′-methylenebis(4-methyl-6-tert-buthylphenol).

An amount of the antioxidant contained in the resin varnish is preferably in the range of 0.01 to 5 percent by mass, and more preferably in the range of 0.1 to 3 percent by mass. By setting the amount of the antioxidant contained in the resin varnish to be within the above range, it is possible to provide the transparent composite substrate 1 having low optical anisotropy and further provide the transparent composite substrate 1 which can make deterioration of the optical anisotropy low even during a reliability test.

A weight average molecular weight of the antioxidant is preferably in the range of 200 to 2000, more preferably in the range of 500 to 1500, and even more preferably in the range of 1000 to 1400. If the weight average molecular weight of the antioxidant is set to be within the above range, it is possible to suppress volatilization of the antioxidant and ensure compatibility with respect to the resin material 3 (for example, an alicyclic epoxy resin). The antioxidant having the weight average molecular weight being within the above range can remain in the transparent composite substrate 1 even after a reliability test such as a heat and humidity treatment, thereby providing the transparent composite substrate 1 which can suppress deterioration of the optical anisotropy.

Examples of the phenol-based antioxidant other than the hindered phenol-based antioxidant include a semi-hindered type phenol-based antioxidant having two substituent groups bonded so as to put a hydroxyl group therebetween, one of the two substituent groups being substituted by a methyl group or the like, and a less-hindered type phenol-based antioxidant having two substituent groups bonded so as to put a hydroxyl group therebetween, both of the two substituent groups being respectively substituted by methyl groups or the like. One of these antioxidants is added into the resin varnish so that an amount of the antioxidant is less than the amount of the hindered phenol-based antioxidant.

Examples of the phosphorus-based antioxidant include tridecyl phosphite and diphenyldecyl phosphite.

Further, by using the hindered phenol-based antioxidant and the phosphorus-based antioxidant in combination, it is possible to provide a synergetic effect thereof. This makes an antioxidant effect of the resin material 3 (for example, an alicyclic epoxy resin) and a suppressive effect for the deterioration of the optical anisotropy of the transparent composite substrate 1 more remarkable. Since mechanisms for the antioxidant effects of the hindered phenol-based antioxidant and the phosphorus-based antioxidant are different from each other, it can be guessed that this synergetic effect is caused by independent actions of the hindered phenol-based antioxidant and the phosphorus-based antioxidant in addition to occurrence of the synergetic effect thereof.

An additive amount of the antioxidant (in particular, the phosphorus-based antioxidant) other than the hindered phenol-based antioxidant is preferably in the range of about 30 to 300 parts by mass, and more preferably in the range of about 50 to 200 parts by mass with respect to the 100 parts by mass of the hindered phenol-based antioxidant. By setting the additive amount of the antioxidant to be within the above range, it is possible to provide the antioxidant effects of the hindered phenol-based antioxidant and the other antioxidant without canceling the antioxidant effects with each other, thereby providing the synergetic effect thereof.

Further, the resin varnish may contain an oligomer or a monomer of a thermoplastic resin or a thermosetting resin or the like as necessary within limits that characteristics of the resin varnish are not impaired. In a case of using such an oligomer or a monomer, a compositional ratio of each component in the resin varnish is appropriately set so that the refractive index of the cured resin material 3 is substantially equal to the refractive index of the glass cloth 2.

The resin varnish can be prepared by mixing components as explained in the above.

[3] Next, the obtained resin varnish is impregnated into the glass cloth 2. For impregnating the resin varnish into the glass cloth 2, for example, a method including dipping the glass cloth 2 into the resin varnish, a method including coating the glass cloth 2 with the resin varnish or the like may be used. Further, after the resin varnish is impregnated into the glass cloth 2, the glass cloth 2 may be further coated with the resin varnish in a state that the resin varnish already impregnated into the glass cloth 2 is cured or not cured.

After that, a dissolving bubbles treatment is carried out to the resin varnish as necessary. Further, the resin varnish is dried as necessary.

[4] Next, the glass cloth 2 in which the resin varnish is impregnated is molded (formed) into a plate-like shape with heating. As a result, the resin material 3 is cured, thereby preparing the composite layer 4.

As conditions for heating, a heating temperature is preferably in the range of about 50 to 300° C. and heating time is preferably in the range of about 0.5 to 10 hours. Further, the heating temperature is more preferably in the range of about 170 to 270° C. and the heating time is more preferably in the range of about 1 to 5 hours.

Further, the heating temperature may be changed during the process. For example, the resin varnish may be heated at temperature of about 50 to 100° C. for about 0.5 to 3 hours firstly (in an initial state) and then heated at temperature of about 200 to 300° C. for about 0.5 to 3 hours.

For example, a polyester film or a polyimide film is used for molding the resin varnish. Further, by pressing the films onto both surface sides of the glass cloth 2 in which the resin varnish is impregnated so as to hold the glass cloth 2 between the films, it is possible to smooth and flat a surface of the resin varnish.

In a case where the resin varnish has photo-hardenability, the resin material 3 (resin varnish) is cured by irradiating ultraviolet rays having a wavelength of about 200 to 400 nm or the like to the resin material 3.

An amount of added optical energy (accumulated amount of light) is preferably in the range of about 5 to 3000 mJ/cm², and more preferably in the range of about 10 to 2000 mJ/cm². By setting the accumulated amount of light to be within the above range, it is possible to evenly, homogeneously and reliably cure the resin material 3.

[5] After that, the gas barrier layers 5 are formed on both surface sides of the composite layer 4.

For example, various liquid phase deposition methods such as a sol-gel method or various vapor phase deposition method such as a vacuum vapor deposition method, an ion plating method, a sputtering method and a CVD method may be used for forming the gas barrier layer 5 on the composite layer 4. Among them, the vapor phase deposition method is preferably used, and the sputtering method or the CVD method is more preferably used.

Further, a RF sputtering method using an oxide of silicon and a nitride of silicon as raw materials or a DC sputtering method using a target containing silicon and introducing reactive gas such as oxygen and nitrogen during processes is used for forming the gas barrier layer 5 containing, for example, a silicon oxynitride.

According to the manner as explained above, the transparent composite substrate 1 can be obtained.

Although the present invention has been described, the present invention is not limited thereto. For example, arbitrary components may be added to the transparent composite substrate and the display element substrate.

Further, in the embodiment described above, although the glass cloth 2 is formed of the glass woven cloth obtained by weaving the plurality of vertical glass yarns 2a and the plurality of the horizontal glass yarns 2b, the glass woven cloth may be obtained by weaving the one vertical glass yarn 2a and the plurality of the horizontal glass yarns 2b, weaving the plurality of vertical glass yarns 2a and the one horizontal glass yarn 2b or weaving the one vertical glass yarn 2a and the one horizontal glass yarn 2b.

As mentioned above, although the examples of the glass cloth include the assembly of the glass fibers obtained by simply bundling the glass fibers and the non-woven cloth, the glass cloth 2 as this embodiment explained above is especially suitable for the present invention. This is because the glass cloth 2 has high uniformity of the refractive index, it is easy to uniformly impregnate the resin material 3 into the glass cloth 2 and it is possible to provide a strong bonding state between the resin material 3 and the glass cloth 2 due to an anchor effect caused by the cured material of the resin material 3 getting into the textures of the glass cloth 2 after the resin material 3 is cured.

In this embodiment, although the gas barrier layers (surface layers) 5 are provided on the both surface sides of the composite layer 4, the gas barrier layer (surface layer) 5 may be provided on either one of the both surface sides of the composite layer 4 according to the present invention. Furthermore, the gas barrier layer (surface layer) 5 may be omitted from the transparent composite substrate according to the present invention.

Further, the structure of the surface layer is not limited to a single-layered structure (only the gas barrier layer 5). The structure of the surface layer may be formed of a multi-layered structure constituted of a plurality of layers containing the gas barrier layer 5. Examples of the surface layer having such a multi-layered structure include a multi-layered structure containing the gas barrier layer 5 and an outermost layer provided on one surface of the gas barrier layer 5, the one surface of the gas barrier layer 5 being opposite to the other surface on which the composite layer is provided. The outermost layer is formed of an organic material or an inorganic material. In this case, the outermost layer preferably has, for example, an anti-light reflection function, an anti-stain adhesion function and the like.

### EMBODIMENTS

Next, description will be given to concrete examples according to the present invention.

1. Producing Transparent Composite Substrate

### Example 1A

(1) Preparing Glass Cloth

First, a NE glass-based glass cloth having 100 mm by 100 mm square (an average thickness of 95 μm and an average wire diameter of 9 μm) was prepared. This NE glass-based glass cloth was dipped into benzyl alcohol (having a refractive index of 1.54) and then acetoxyethoxyethane (having a refractive index of 1.406) was added into the benzyl alcohol little by little. Every time that the refractive index of the benzyl alcohol was changed, it was checked whether the glass cloth became substantially transparent by holding the glass cloth against a fluorescent light. Further, when a substantially transparent part appeared in the glass cloth dipped into mixing liquid, a refractive index of the mixing liquid was measured.

The refractive index of the glass cloth was defined by a refractive index difference between a refractive index of mixing liquid in which a substantially transparent part first appeared and a refractive index of mixing liquid in which a substantially transparent part finally appeared. Further, an average refractive index of the glass cloth was defined by a refractive index of mixing liquid in which a square measure of a transparent part in the glass cloth reached a maximum value. The results of these measurements are shown in Table 1.

In this glass cloth, the number of the glass yarns in the MD direction (vertical direction) per one inch width was 58 and the number of the glass yarns in the TD direction (horizontal direction) per one inch width was 50. Namely, when the number of the glass yarns in the TD direction per one inch width was defined as “1”, a ratio (relative value) of the number of the glass yarns in the MD direction was 1.16.

Further, in this glass cloth, when a percentage of the glass fibers occupying in a cross section of the glass yarns in the TD direction per one inch width was defined as “1”, a ratio (relative value) of a percentage of the glass fibers occupying in a cross section of the glass yarns in the MD direction per one inch width was 1.35.

A twist number of the glass fiber bundle of the glass cloth in the MD direction per one inch was 1.0 and a twist number of the glass fiber bundle of the glass cloth in the TD direction per one inch was 1.0.

(2) Preparing Resin Varnish

Next, a resin varnish was prepared by mixing an alicyclic epoxy resin (“E-DOA” made by Daicel Chemical Industries Ltd. and having Tg:>250° C.) having a structure represented by the above chemical formula (2) and a group “—CH(CH₃)₂—” as a group “—X—” in the chemical formula (2), a silsesquioxane-based oxetane (“OX-SQ-H” made by TOAGOSEI Co, Ltd.), an optical cation polymerization initiator (“SP-170” made by ADEKA Corporation) as a curing agent and methyl isobutyl ketone as solvent at a ratio shown in Table 1. In this regard, a refractive index of “E-DOA” being cross-linked was 1.513 and a refractive index of “OX-SQ-H” being cross-linked was 1.47.

An Abbe number of a matrix resin was measured as follows.

First, a liquid film was formed by coating a mold-released glass plate with the resin varnish. After that, by putting another mold-released glass plate on the liquid film, the liquid film was provided between the two glass plates. In this time, spacers having a thickness of 200 μm were provided between the two glass plates so as to surround four sides. A resin film (matrix resin) having a thickness of 200 μm was prepared by irradiating the liquid film by ultraviolet rays of 1100 mJ/cm² with a high-pressure mercury lamp and then heating it at temperature of 250° C. for 2 hours. After that, an Abbe number of the resin film was measured with an Abbe refractometer (“DR-A1” made by ATAGO Co, Ltd.). The results are shown in Table 1.

(3) Impregnating and Curing Resin Varnish

Next, the obtained resin varnish was impregnated into the glass cloth and then a dissolving bubbles treatment was carried out to the resin varnish. After that, the resin varnish was dried.

Next, the glass cloth in which the resin varnish was impregnated according to the above step was put between two mold-released glass plates and then irradiated with ultraviolet rays of 1100 mJ/cm² with a high-pressure mercury lamp. After that, a composite layer having a thickness of 97 μm (a contained amount of the glass cloth was 57 percent by mass) was prepared by heating the glass cloth at temperature of 250° C. for 2 hours.

(4) Forming Smooth Layers (Intermediate Layers)

A coating material was prepared by mixing 100 parts by mass of an alicyclic epoxy resin (“E-DOA” made by Daicel Chemical Industries Ltd. and having Tg:>250° C.) having a structure represented by the above chemical formula (2) and a group “—CH(CH₃)₂—” as a group “—X—” in the chemical formula (2) with 1 part by mass of an optical cation polymerization initiator (“SP-170” made by ADEKA Corporation). Next, both surface sides of the composite layer were coated with the coating material by a bar-coater and then irradiated with ultraviolet rays of 1100 mJ/cm² with a high-pressure mercury lamp. After that, smooth layers having an average thickness of 5 μm were formed by heating the coated composite layer at temperature of 250° C. for 2 hours.

(5) Forming Gas Barrier Layer (Surface Layer)

Next, the composite layer on which the smooth layers were formed was set in a chamber of a RF sputtering apparatus. Ar gas and O₂ gas were respectively introduced into the chamber at pressures of 0.5 Pa and 0.005 Pa after the chamber was decompressed. After that, discharge was carried out by adding RF power of 0.3 kW between a Si₃N₄ target and the composite layer set in the chamber.

After the discharge became stable, a forming of a gas barrier layer formed of SiOₓN_{y} was started by opening a shutter provided between the target and the composite layer. After that, the forming of the gas barrier layer was ended by closing the shutter when an average thickness of the gas barrier layer became 100 nm. Finally, a produced transparent composite substrate was obtained by releasing the gas from the chamber to the atmosphere.

### Examples 2A to 12A and Comparative Examples 1A to 4A

Transparent composite substrates of other examples and comparative examples were respectively obtained in the same manner as example 1A except that manufacturing conditions were changed as shown in Tables 1 and 2.

In examples 2A, 3A, 4A, 8A and 12A and comparative examples 2A and 4A, a hydrogenated biphenyl-type alicyclic epoxy resin (“E-BP” made by Daicel Chemical Industries Ltd. and having Tg:>250° C.) having a structure shown in the above chemical formula (1) was used as the resin monomer. A refractive index of “E-BP” being cross-linked was 1.522.

In examples 3A and 8A and comparative example 2A, a T glass-based glass cloth (having an average thickness of 95 μm and an average line diameter of 9 μm) was used as the glass cloth. In example 5A, a S glass-based glass cloth (having an average thickness of 95 μm and an average line diameter of 9 μm) was used as the glass cloths. In comparative examples 3A and 4A, an E glass-based glass cloth (having an average thickness of 95 μm and an average line diameter of 9 μm) was used as the glass cloth.

A ratio (relative value) of a percentage of the glass fibers occupying in a cross section of the glass yarns in the MD direction per one inch width (which was obtained by defining a percentage of the glass fibers occupying in a cross section of the glass yarns in the TD direction per one inch width as “1”), an average refractive index and a refractive index difference of the glass cloth used in each example are shown in Tables 1 and 2.

In example 5A, an alicyclic acrylic resin (“IRR-214K” made by DAICEL-CYTEC Ltd.) having a structure shown in the following chemical formula (6) was used as the resin monomer. A refractive index of “IRR-214K” being cross-linked was 1.529.

[chemical structure]

In example 5A, the glass cloth in which the resin varnish was impregnated was irradiated with ultraviolet rays having a wavelength of 365 nm when the resin varnish was cured. Further, an optical radical polymerization initiator (“Irgacure 184” made by Ciba Japan Corporation) was used as the polymerization initiator.

In comparative examples 3A and 4A, a mixture of an alicyclic epoxy resin and a bisphenol-A-type epoxy resin (“EPIKOTE 828” made by MITUBISHI CHEMICAL Corporation) is used as the resin monomer.

In examples 3A and 7A and comparative examples 1A, 2A, 3A and 4A, a thermal cation polymerization initiator (“SI-100L” made by SANSHIN CHEMICAL CO., LTD.) as the curing agent. Further, the glass cloth in which the resin varnish was impregnated was provided between tow mold-released glass plates and heated the glass cloth at temperature of 80° C. for 2 hours. After that, a composite layer was prepared by heating the glass cloth at temperature of 250° C. for 2 hours.

### Examples 1B to 12B and Comparative Examples 1B to 5B

A transparent composite substrate of example 1B was obtained in the same manner as example 1A except that a contained amount of the glass cloth in the composite layer was changed to 60 percent by mass. Transparent composite substrates of examples 2B to 12B and comparative examples 1B to 5B were respectively obtained in the same manner as example 1B except that manufacturing conditions were changed as shown in Tables 3 and 4.

When a temperature at which a weight of an alicyclic epoxy resin or an alicyclic acrylic resin (which is a major component contained in the resin material of the composite layer) decreases by 5% is defined as “Td” [° C.] and a melting point of an inorganic material of the gas barrier layer is defined as “Tm” [° C.], an obtained value of “Tm−Td” is shown in Tables 3 and 4.

In examples 3B and 8B and comparative example 2B, a T glass-based glass cloth (having an average thickness of 95 μm and an average line width of 9 μm) was used as the glass cloth. In example 5B, a S glass-based glass cloth (having an average thickness of 95 μm and an average line width of 9 μm) was used as the glass cloth. In comparative examples 4B and 5B, an E glass-based glass cloth (having an average thickness of 95 μm and an average line width of 9 μm) was used as the glass cloth.

A ratio (relative value) of a percentage of the glass fibers occupying in a cross section of the glass yarns in the MD direction per one inch width (which was obtained by defining a percentage of the glass fibers occupying in a cross section of the glass yarns in the TD direction per one inch width as “1”), an average refractive index and a refractive index difference of the glass cloth used in each example are shown in Tables 3 and 4.

In example 5B and comparative examples 4B and 5B, the glass cloth in which the resin varnish was impregnated was irradiated with ultraviolet rays having a wavelength of 365 nm when the resin varnish was cured.

In example 2B, an average thickness of the gas barrier layer was 50 nm. In example 8B, an average thickness of the gas barrier layer was 250 nm.

### Examples 1C to 11C and Comparative Examples 1C to 3C, 5C and 6C

A transparent composite substrate of example 1C was obtained in the same manner as example 1A except that a contained amount of the glass cloth in the composite layer was changed to 65 percent by mass. Transparent composite substrates of examples 2C to 11C and comparative examples 1C to 3C, 5C and 6C were respectively obtained in the same manner as example 1C except that manufacturing conditions were changed as shown in Tables 5 and 6.

When a temperature at which a weight of an alicyclic epoxy resin or an alicyclic acrylic resin (which is a major component contained in the resin material of the composite layer) decreases by 5% is defined as “Td” [° C.] and a melting point of an inorganic material of the gas barrier layer is defined as “Tm” [° C.], an obtained value of “Tm−Td” is shown in Tables 5 and 6.

In example 3C and comparative example 2C, a T glass-based glass cloth (having an average thickness of 95 μm and an average line width of 9 μm) was used as the glass cloth. In example 5C, a S glass-based glass cloth (having an average thickness of 95 μm and an average line width of 9 μm) was used as the glass cloth. In comparative examples 5C and 6C, an E glass-based glass cloth (having an average thickness of 95 μm and an average line width of 9 μm) was used as the glass cloth.

A ratio (relative value) of a percentage of the glass fibers occupying in a cross section of the glass yarns in the MD direction per one inch width (which was obtained by defining a percentage of the glass fibers occupying in a cross section of the glass yarns in the TD direction per one inch width as “1”), an average refractive index and a refractive index difference of the glass cloth used in each example are shown in Tables 5 and 6.

In example 5C and comparative examples 5C and 6C, the glass cloth in which the resin varnish was impregnated was irradiated with ultraviolet rays having a wavelength of 365 nm when the resin varnish was cured.

In example 2C, an average thickness of the gas barrier layer was 50 nm. In example 5C, an average thickness of the gas barrier layer was 250 nm.

### Comparative Example 4C

In comparative example 4C, a resin film was obtained by using the same material as example 1C except that the glass cloth was not used. In this manner for manufacturing the transparent composite layer, a liquid film was prepared by coating a mold-released glass plate with a prepared resin varnish. After that, by putting another mold-released glass plate on the liquid film, the liquid film was put between the two glass plates was prepared. In this time, spacers having a thickness of 100 μm were provided between the two glass plates so as to surround four sides. The resin film having a thickness of 105 μm was prepared by irradiating the liquid film with ultraviolet rays of 1100 mJ/cm² with a high-pressure mercury lamp and then heating it at temperature of 250° C. for 2 hours.

2. Evaluations for Transparent Composite Substrate

2.1 Evaluation for Dimension Change Due to Humidity

The transparent composite substrates obtained in the examples and the comparative examples were respectively cut out to samples having a dimension of 100 mm×100 mm. After that, lengths of four sides of each sample were measured with a non-contact image measuring apparatus (“SQVH 606” made by Mitutoyo Corporation) under an environment of 25° C./50% RH. Next, after the samples were treated under an environment of 25° C./90% RH/24 hours, the dimensions of the four sides of each sample were measured again. According to the two measurement values of each sample, dimension changes of the samples due to the humidity treatment were measured. The measurements of the dimension change were carried out in both of the MD direction and the TD direction along with the weaving directions of the glass cloth. The Evaluation results are shown in Tables 1 to 6.

2.2 Evaluation for Haze

The transparent composite substrates obtained in the examples and the comparative examples were respectively cut out to samples having a dimension of 100 mm×100 mm. After that, nine points uniformly dispersed on each sample were selected and haze values of the nine points were measured with a turbidity meter (“NDH 2000” made by NIPPON DENSHOKU INDUSTRIES Co., Ltd.) using conditions defined in “JIS K 7136” under an environment of 25° C./50% RH. The obtained average haze values are shown in Tables 1 to 6.

2.3 Evaluations for Change Amount of Haze

Next, the samples were treated under an environment of 25° C./90% RH/24 hours. After that, haze values of the same points on the samples as the above section 2.2 were measured in the same manner as the above section 2.2 and then haze differences with respect to the haze values measured in the above section 2.2 were obtained.

2.4 Evaluation for Gas Barrier Property

A water vapor permeation rate defined in “JIS K 7129 B” and an oxygen permeation rate defined in “JIS K 7126 B” of each of the transparent composite substrates obtained in the examples and the comparative examples were measured. Conditions for measurement are shown in Tables 1 to 6.

2.5 Evaluation for Abrasion Resistance

An abrasion resistance of each of the transparent composite substrates obtained in the examples and the comparative examples was evaluated according to a test method for a mechanical property of a coating film defined in “JIS K 5600-5-4” (a scratch hardness (pencil method)). This abrasion resistance was evaluated by evaluating a measured hardness according to the following evaluation criteria.

<Evaluation Criteria for Abrasion Resistance>

A: The abrasion resistance is evaluated as “A” when the scratch hardness is harder than “2H”.

B: The abrasion resistance is evaluated as “B” when the scratch hardness is “F” or “H”.

C: The abrasion resistance is evaluated as “C” when the scratch hardness is softer than “B”.

The evaluation results for the abrasion resistance are shown in Tables 1 to 6.

2.6 Measurement for Coefficient of Linear Expansion (CTE)

The transparent composite substrates obtained in examples 1C to 11C and comparative examples 1C to 3C, 5C and 6C and the resin film obtained in comparative example 4C were respectively cut out to samples. After that, each of the samples was set in a thermal stress distortion measuring apparatus (“TMA/SS120C type” made by Seiko Instruments Inc.). Next, an ambient temperature was raised from 30° C. to 150° C. at temperature raising rate of 5° C./minute under nitrogen atmosphere with no pressure and then the sample was once cooled to 0° C. After that, a coefficient of linear expansion was measured by stretching the sample with pressure of 5 g with heating the ambient temperature from 30° C. to 150° C. at temperature raising rate of 5° C./minute. In this stage, a coefficient of linear expansion in the MD direction of the sample was measured.

The measurement results are shown in Tables 5 and 6.

TABLE 1

| | | | | | Ex. | Ex. | Ex. | Ex. | Ex. | Ex. | Ex. | Ex. |
|---|---|---|---|---|---|---|---|---|---|---|---|---|
| | Conditions for manufacturing transparent composite substrate | | | | 1A | 2A | 3A | 4A | 5A | 6A | 7A | 8A |
| Composite layer | Resin monomer | Alicyclic epoxy resin | E-DOA | Parts by mass | 96 | 40 | | | | 96 | 96 | |
| | | | E-BP | Parts by mass | | 57 | 100 | 95 | | | | 100 |
| | | Alicyclic acrylic resin | IRR-214K | Parts by mass | | | | | 100 | | | |
| | | Bisphenol-A type epoxy resin | EPIKOTE 828 | Parts by mass | | | | | | | | |
| | | Silsesquioxane-based compound | OX-SQ-H | Parts by mass | 4 | 3 | | 5 | | 4 | 4 | |
| | Curing agent | Optical cation polymerization initiator | SP-170 | Parts by mass | 1 | 1 | | 1 | | 1 | | 1 |
| | | Thermal cation polymerization initiator | SI-100L | Parts by mass | | | 1 | | | | 1 | |
| | | Optical radical polymerization initiator | Irgacure184 | Parts by mass | | | | | 1 | | | |
| | Solvent | Methyl isobutyl ketone | | Parts by mass | 25.25 | 25.25 | | | | 25.25 | 25.25 | |
| | Refractive index of matrix resin | | | — | 1.510 | 1.512 | 1.522 | 1.510 | 1.529 | 1.511 | 1.512 | 1.522 |
| | Glass cloth | NE glass-based glass cloth | | Percent by mass | 57 | 57 | | 57 | | 57 | 57 | |
| | | T glass-based glass cloth | | Percent by mass | | | 57 | | | | | 57 |
| | | S glass-based glass cloth | | Percent by mass | | | | | 57 | | | |
| | | E glass-based glass cloth | | Percent by mass | | | | | | | | |
| | | Average refractive index | | — | 1.511 | 1.511 | 1.522 | 1.510 | 1.529 | 1.512 | 1.511 | 1.520 |
| | | Refractive index difference | | — | 0.002 | 0.004 | 0.007 | 0.003 | 0.006 | 0.008 | 0.003 | 0.006 |
| | | Cross-section ratio | | — | 1.35 | 1.27 | 1.38 | 1.23 | 1.06 | 1.08 | 1.32 | 1.21 |
| | | Ratio of the number of glass yarns | | — | 1.16 | 1.13 | 1.17 | 1.11 | 1.03 | 1.04 | 1.15 | 1.10 |
| | | Twist number | MD direction | Z/inch | 1.0 | 1.0 | 1.0 | 1.0 | 1.0 | 1.0 | 1.0 | 1.0 |
| | | | TD direction | Z/inch | 1.0 | 1.0 | 1.0 | 1.0 | 1.0 | 1.0 | 1.0 | 1.0 |
| Smooth | Resin monomer | Alicyclic epoxy resin | E-DOA | Parts by mass | 100 | 100 | 100 | 100 | 100 | 100 | 100 | 100 |
| layer | Curing agent | Optical cation polymerization initiator | SP-170 | Parts by mass | 1 | 1 | 1 | 1 | 1 | 1 | 1 | 1 |

| | | | | | | | | | | | |
|---|---|---|---|---|---|---|---|---|---|---|---|
| Gas barrier layer | Silicon compound | SiOxNy | — | ◯ | ◯ | ◯ | ◯ | ◯ | ◯ | ◯ | ◯ |
| | | x | — | 1.5 | 1.8 | 1.2 | 2 | 1 | 1.5 | 0.6 | 0.4 |
| | | y | — | 0.5 | 0.2 | 0.8 | 0 | 1 | 1 | 0.9 | 0.9 |
| | | x/(x + y) | — | 0.75 | 0.9 | 0.6 | 1 | 0.5 | 0.6 | 0.40 | 0.31 |
| Evaluation results | Abbe number of cured resin material | | — | 52 | 51 | 50 | 51 | 50 | 51 | 52 | 51 |
| | Average thickness | | μm | 97 | 96 | 98 | 99 | 98 | 98 | 96 | 99 |
| | Dimension change due to humidity | MD direction | ppm | 42 | 46 | 42 | 46 | 54 | 53 | 71 | 76 |
| | | TD direction | ppm | 45 | 49 | 46 | 50 | 57 | 57 | 74 | 82 |
| | | Dimension change | — | 1.07 | 1.06 | 1.11 | 1.09 | 1.05 | 1.06 | 1.04 | 1.08 |
| | | TD/MD ratio | | | | | | | | | |
| | Haze (average of nine points) | \textcircled{1} Initial value | % | 2.1 | 1.7 | 1.9 | 2.2 | 2.3 | 1.8 | 2.0 | 2.4 |
| | | \textcircled{2} 24 hours treatment later | % | 2.3 | 1.8 | 2.0 | 2.5 | 2.8 | 2.4 | 2.8 | 2.8 |
| | | \textcircled{2} − \textcircled{1} | % | 0.2 | 0.1 | 0.1 | 0.3 | 0.5 | 0.6 | 0.8 | 0.4 |

| | | | | | | | | | |
|---|---|---|---|---|---|---|---|---|---|
| Water vapor permeation rate | g/m²/day/40° C., 90% RH | <0.01 | <0.01 | <0.01 | 0.01 | 0.01 | 0.02 | 0.06 | 0.12 |
| Oxgen permeation rate | cm³/m²/day/1 atm/23° C. | <0.1 | <0.1 | <0.1 | 0.1 | 0.1 | 0.2 | <0.01 | <0.1 |
| Abrasion resistance | — | A | A | A | B | B | B | B | B |

TABLE 2

| | | | | | Ex. | Ex. | Ex. | Ex. |
|---|---|---|---|---|---|---|---|---|
| | Conditions for manufacturing transparent composite substrate | | | | 9A | 10A | 11A | 12A |
| Composite | Resin monomer | Alicyclic epoxy resin | E-DOA | Parts by mass | 96 | 96 | 95 | 40 |
| layer | | | E-BP | Parts by mass | | | | 57 |
| | | Alicyclic acrylic resin | IRR-214K | Parts by mass | | | | |
| | | Bisphenol-A type epoxy resin | EPIKOTE 828 | Parts by mass | | | | |
| | | Silsesquioxane-based compound | OX-SQ-H | Parts by mass | 4 | 4 | 5 | 3 |
| | Curing agent | Optical cation polymerization initiator | SP-170 | Parts by mass | 1 | 1 | 1 | 1 |
| | | Thermal cation polymerization initiator | SI-100L | Parts by mass | | | | |
| | | Optical radical polymerization initiator | Irgacure184 | Parts by mass | | | | |
| | Solvent | Methyl isobutyl ketone | | Parts by mass | 25.25 | 25.25 | 25.25 | 25.25 |
| | Refractive index of matrix resin | | | | 1.510 | 1.511 | 1.510 | 1.512 |
| | Glass cloth | NE glass-based glass cloth | | Percent by mass | 57 | 57 | 57 | 57 |
| | | T glass-based glass cloth | | Percent by mass | | | | |
| | | S glass-based glass cloth | | Percent by mass | | | | |
| | | E glass-based glass cloth | | Percent by mass | | | | |
| | | Average refractive index | | — | 1.511 | 1.511 | 1.511 | 1.510 |
| | | Refractive index difference | | — | 0.002 | 0.003 | 0.008 | 0.009 |
| | | Cross-section ratio | | — | 1.35 | 1.35 | 1.32 | 1.21 |
| | | Ratio of the number of glass yarns | | — | 1.16 | 1.16 | 1.15 | 1.10 |
| | | Twist number | MD direction | Z/inch | 1.5 | 0.5 | 1.0 | 1.0 |
| | | | TD direction | Z/inch | 1.5 | 0.5 | 1.0 | 1.0 |
| Smooth | Resin monomer | Alicyclic epoxy resin | E-DOA | Parts by mass | 100 | 100 | | 100 |
| layer | Curing agent | Optical cation polymerization initiator | SP-170 | Parts by mass | 1 | 1 | | 1 |
| Gas barrier | Silicon compound | | SiOxNy | — | ◯ | ◯ | ◯ | ◯ |
| layer | | | x | — | 1.5 | 1.5 | 0 | 0.5 |
| | | | y | — | 0.5 | 0.5 | 1.3 | 2 |
| | | | x/(x + y) | — | 0.75 | 0.75 | 0 | 0.20 |
| Evaluation | Abbe number of cured resin material | | | — | 50 | 52 | 50 | 51 |
| results | Average thickness | | | μm | 99 | 95 | 97 | 97 |
| | Dimension change due to humidity | | MD direction | ppm | 39 | 49 | 55 | 69 |
| | | | TD direction | ppm | 42 | 52 | 61 | 74 |
| | | | Dimension | — | 1.09 | 1.06 | 1.11 | 1.08 |
| | | | change TD/MD | | | | | |
| | | | ratio | | | | | |
| | Haze (average of nine points) | | \textcircled{1} Initial | % | 2.7 | 1.6 | 2.3 | 2.7 |
| | | | value | | | | | |
| | | | \textcircled{2} After | % | 2.9 | 1.7 | 3.5 | 4.1 |
| | | | 24 hours | | | | | |
| | | | treatment | | | | | |
| | | | \textcircled{2} \textcircled{1} | % | 0.2 | 0.1 | 1.2 | 1.4 |
| | Water vapor permeation rate | | g/m²/day/40° C., 90% RH | | <0.01 | <0.01 | 0.18 | 0.15 |
| | Oxgen permeation rate | | cm³/m²/day/1 atm/23° C. | | <0.1 | <0.1 | 10< | <0.1 |
| | Abrasion resistance | | — | | A | A | A | B |
| | | | | | Cf. | Cf. | Cf. | Cf. |
| | Conditions for manufacturing transparent composite substrate | | | | 1A | 2A | 3A | 4A |
| Composite | Resin monomer | Alicyclic epoxy resin | E-DOA | Parts by mass | 95 | | 39 | |
| layer | | | E-BP | Parts by mass | | 100 | | 43 |
| | | Alicyclic acrylic resin | IRR-214K | Parts by mass | | | | |
| | | Bisphenol-A type epoxy resin | EPIKOTE 828 | Parts by mass | | | 61 | 57 |
| | | Silsesquioxane-based compound | OX-SQ-H | Parts by mass | 5 | | | |
| | Curing agent | Optical cation polymerization initiator | SP-170 | Parts by mass | | | | |
| | | Thermal cation polymerization initiator | SI-100L | Parts by mass | 1 | 1 | 1 | 1 |
| | | Optical radical polymerization initiator | Irgacure184 | Parts by mass | | | | |
| | Solvent | Methyl isobutyl ketone | | Parts by mass | 25.25 | | 25.25 | |
| | Refractive index of matrix resin | | | | 1.510 | 1.520 | 1.559 | 1.560 |
| | Glass cloth | NE glass-based glass cloth | | Percent by mass | 57 | | | |
| | | T glass-based glass cloth | | Percent by mass | | 57 | | |
| | | S glass-based glass cloth | | Percent by mass | | | | |
| | | E glass-based glass cloth | | Percent by mass | | | 57 | 57 |
| | | Average refractive index | | — | 1.511 | 1.521 | 1.559 | 1.557 |
| | | Refractive index difference | | — | 0.017 | 0.022 | 0.008 | 0.005 |
| | | Cross-section ratio | | — | 1.25 | 1.11 | 1.35 | 1.32 |
| | | Ratio of the number of glass yarns | | — | 1.12 | 1.05 | 1.16 | 1.15 |
| | | Twist number | MD direction | Z/inch | 1.0 | 1.0 | 1 | 1 |
| | | | TD direction | Z/inch | 1.0 | 1.0 | 1 | 1 |
| Smooth | Resin monomer | Alicyclic epoxy resin | E-DOA | Parts by mass | | | 100 | 100 |
| layer | Curing agent | Optical cation polymerization initiator | SP-170 | Parts by mass | | | 1 | 1 |

| Gas barrier | Silicon compound | SiOxNy | — | | | ◯ | ◯ |
|---|---|---|---|---|---|---|---|
| layer | | x | — | | | 1.5 | 1.5 |
| | | y | — | | | 0.5 | 0.5 |
| | | x/(x + y) | — | | | 0.75 | 0.75 |
| Evaluation | Abbe number of cured resin material | | — | 52 | 53 | 38 | 40 |
| results | Average thickness | | μm | 97 | 98 | 97 | 98 |
| | Dimension change due to humidity | MD direction | ppm | 442 | 447 | 44 | 46 |
| | | TD direction | ppm | 500 | 508 | 51 | 50 |
| | | Dimension | — | 1.13 | 1.14 | 1.15 | 1.09 |
| | | change TD/MD | | | | | |
| | | ratio | | | | | |
| | Haze (average of nine points) | \textcircled{1} Initial | % | 3.5 | 3.5 | 5.1 | 5.3 |
| | | value | | | | | |
| | | \textcircled{2} After | % | 5.7 | 5.9 | 8.2 | 8.8 |
| | | 24 hours | | | | | |
| | | treatment | | | | | |
| | | \textcircled{2} \textcircled{1} | % | 2.2 | 2.4 | 3.1 | 3.5 |

| | | | | | |
|---|---|---|---|---|---|
| Water vapor permeation rate | g/m²/day/40° C., 90% RH | 10< | 10< | <0.01 | <0.01 |
| Oxgen permeation rate | cm³/m²/day/1 atm/23° C. | 10< | 10< | <0.1 | <0.1 |
| Abrasion resistance | — | C | C | A | A |

As is clear from Tables 1 and 2, in the transparent composite substrate obtained in each of the examples, the haze value is small and the change amount of haze after the humidity treatment is also small. Therefore, it becomes apparent that the transparent composite substrate obtained in each of the examples has superior optical characteristics and can keep the superior optical characteristics even under harsh environments over the long term. Further, in almost of the transparent composite substrates obtained the examples, the oxygen permeation rate and the coefficient of linear expansion are also small. In addition, it is confirmed that it is possible to improve the abrasion resistance of the transparent composite substrate by optimizing the abundance ratio of oxygen atoms and nitrogen atoms in the silicon compound forming the gas barrier layer.

On the other hand, some transparent composite substrates obtained in the comparative examples have large haze values. In addition, although the haze values of the transparent composite substrates obtained in the comparative examples are small at the time of manufacturing, it becomes apparent that the haze values of the transparent composite substrates are rapidly deteriorated due to an acceleration test such as the humidity treatment. Since some transparent composite substrates obtained in the comparative examples have a large refractive index difference of the glass cloth, a large water vapor permeation rate or a large coefficient of linear expansion, it can be guessed that these factors lead to the deterioration of haze.

TABLE 3

| | | | | | Ex. | Ex. | Ex. | Ex. | Ex. | Ex. | Ex. | Ex. | Ex. |
|---|---|---|---|---|---|---|---|---|---|---|---|---|---|
| | Conditions for manufacturing transparent composite substrate | | | | 1B | 2B | 3B | 4B | 5B | 6B | 7B | 8B | 9B |
| Composite | Resin monomer | Alicyclic epoxy resin | E-DOA | Parts by mass | 96 | 40 | | | | 96 | 96 | | 96 |
| layer | | | E-BP | Parts by mass | | 57 | 100 | 95 | | | | 100 | |
| | | Alicyclic acrylic resin | IRR-214K | Parts by mass | | | | | 100 | | | | |
| | | Bisphenol-A type epoxy resin | EPIKOTE 828 | Parts by mass | | | | | | | | | |
| | | Silsesquioxane-based compound | OX-SQ-H | Parts by mass | 4 | 3 | | 5 | | 4 | 4 | | 4 |
| | Curing agent | Optical cation polymerization initiator | SP-170 | Parts by mass | 1 | 1 | | 1 | | 1 | | 1 | 1 |
| | | Thermal cation polymerization initiator | SI-100L | Parts by mass | | | 1 | | | | 1 | | |
| | | Optical radical polymerization initiator | Irgacure184 | Parts by mass | | | | | 1 | | | | |
| | Solvent | Methyl isobutyl ketone | | Parts by mass | 25.25 | 25.25 | | | | 25.25 | 25.25 | | 25.25 |
| | Refractive index of matrix resin | | | — | 1.510 | 1.512 | 1.522 | 1.510 | 1.529 | 1.511 | 1.512 | 1.522 | 1.510 |
| | Glass cloth | NE glass-based glass cloth | | Percent by mass | 60 | 60 | | 60 | | 60 | 60 | | 60 |
| | | T glass-based glass cloth | | Percent by mass | | | 60 | | | | | 60 | |
| | | S glass-based glass cloth | | Percent by mass | | | | | 60 | | | | |
| | | E glass-based glass cloth | | Percent by mass | | | | | | | | | |
| | | Average refractive index | | — | 1.511 | 1.511 | 1.522 | 1.510 | 1.529 | 1.512 | 1.511 | 1.520 | 1.511 |
| | | Refractive index difference | | — | 0.002 | 0.004 | 0.007 | 0.003 | 0.006 | 0.008 | 0.003 | 0.006 | 0.002 |
| | | Cross-section ratio | | — | 1.35 | 1.27 | 1.38 | 1.23 | 1.06 | 1.08 | 1.32 | 1.21 | 1.35 |
| | | Ratio of the number of glass yarns | | — | 1.16 | 1.13 | 1.17 | 1.11 | 1.03 | 1.04 | 1.15 | 1.10 | 1.16 |
| | | Twist number | MD direction | Z/inch | 1.0 | 1.0 | 1.0 | 1.0 | 1.0 | 1.0 | 1.0 | 1.0 | 1.5 |
| | | | TD direction | Z/inch | 1.0 | 1.0 | 1.0 | 1.0 | 1.0 | 1.0 | 1.0 | 1.0 | 1.5 |
| Smooth | Resin monomer | Alicyclic epoxy resin | E-DOA | Parts by mass | 100 | 100 | 100 | 100 | 100 | 100 | 100 | 100 | 100 |
| layer | Curing agent | Optical cation polymerization initiator | SP-170 | Parts by mass | 1 | 1 | 1 | 1 | 1 | 1 | 1 | 1 | 1 |

| | | | | | | | | | | | | |
|---|---|---|---|---|---|---|---|---|---|---|---|---|
| Gas barrier | Silicon compound | SiOxNy | — | ◯ | ◯ | ◯ | ◯ | ◯ | ◯ | ◯ | ◯ | ◯ |
| layer | | x | — | 1.5 | 1.8 | 1.2 | 2 | 1 | 1.5 | 0.6 | 0.4 | 1.5 |
| | | y | — | 0.5 | 0.2 | 0.8 | 0 | 1 | 1 | 0.9 | 0.9 | 0.5 |
| | | x/(x + y) | — | 0.75 | 0.90 | 0.60 | 1.00 | 0.50 | 0.60 | 0.40 | 0.31 | 0.75 |
| | Zinc oxide | ZnO | — | | | | | | | | | |
| | Ferric oxide(III) | Fe₂O₃ | — | | | | | | | | | |
| Tm-Td | | | ° C. | 1308 | 1285 | 1330 | 1320 | 1345 | 1380 | 1360 | 1399 | 1308 |
| Evaluation | Abbe number of cured resin material | | — | 52 | 51 | 50 | 51 | 50 | 51 | 52 | 51 | 50 |
| results | Average thickness | | μm | 97 | 96 | 98 | 99 | 98 | 98 | 96 | 99 | 99 |
| | Dimension change due to humidity | MD direction | ppm | 40 | 44 | 39 | 44 | 52 | 51 | 41 | 43 | 37 |
| | | TD direction | ppm | 43 | 46 | 44 | 47 | 54 | 54 | 42 | 47 | 40 |
| | | Dimension | — | 1.07 | 1.06 | 1.11 | 1.09 | 1.05 | 1.06 | 1.04 | 1.08 | 1.09 |
| | | change | | | | | | | | | | |
| | | TD/MD ratio | | | | | | | | | | |
| | Haze (average of nine points) | \textcircled{1} Initial | % | 2.1 | 1.7 | 1.9 | 2.2 | 2.3 | 1.8 | 2.0 | 2.4 | 2.7 |
| | | value | | | | | | | | | | |
| | | \textcircled{2} After 24 | % | 2.3 | 1.8 | 2.0 | 2.5 | 2.8 | 2.4 | 2.8 | 2.8 | 2.9 |
| | | hours treatment | | | | | | | | | | |
| | | \textcircled{2} − \textcircled{1} | % | 0.2 | 0.1 | 0.1 | 0.3 | 0.5 | 0.6 | 0.8 | 0.4 | 0.2 |

| | | | | | | | | | | |
|---|---|---|---|---|---|---|---|---|---|---|
| Water vapor permeation rate | g/m²/day/40° C. 90% RH | <0.01 | <0.01 | <0.01 | 0.01 | 0.01 | 0.02 | 0.06 | 0.12 | <0.01 |
| Oxgen permeation rate | cm³/m²/day/1 atm/23° C. | <0.1 | <0.1 | <0.1 | 0.1 | 0.1 | 0.2 | <0.01 | <0.1 | <0.1 |
| Abrasion resistance | — | A | A | A | B | B | B | B | B | A |

TABLE 4

| | | | | | Ex. | Ex. | Ex. | Cf. | Cf. | Cf. | Cf. | Cf. |
|---|---|---|---|---|---|---|---|---|---|---|---|---|
| | Conditions for manufacturing transparent composite substrate | | | | 10B | 11B | 12B | 1B | 2B | 3B | 4B | 5B |
| Composite | Resin monomer | Alicyclic epoxy resin | E-DOA | Parts by mass | 96 | 95 | 40 | 95 | | 96 | 39 | |
| layer | | | E-BP | Parts by mass | | | 57 | | 100 | | | 43 |
| | | Alicyclic acrylic resin | IRR-214K | Parts by mass | | | | | | | | |
| | | Bisphenol-A type epoxy resin | EPIKOTE 828 | Parts by mass | | | | | | | 61 | 57 |
| | | Silsesquioxane-based compound | OX-SQ-H | Parts by mass | 4 | 5 | 3 | 5 | | 4 | | |
| | Curing agent | Optical cation polymerization initiator | SP-170 | Parts by mass | 1 | 1 | 1 | | | 1 | | |
| | | Thermal cation polymerization initiator | SI-100L | Parts by mass | | | | 1 | 1 | | | |
| | | Optical radical polymerization initiator | Irgacure184 | Parts by mass | | | | | | | 1 | 1 |
| | Solvent | Methyl isobutyl ketone | | Parts by mass | 25.25 | 25.25 | 25.25 | 25.25 | | 25.25 | 25.25 | |
| | Refractive index of matrix resin | | | — | 1.511 | 1.510 | 1.512 | 1.510 | 1.520 | 1.510 | 1.559 | 1.560 |
| | Glass cloth | NE glass-based glass cloth | | Percent by mass | 60 | 60 | 60 | 60 | | 60 | | |
| | | T glass-based glass cloth | | Percent by mass | | | | | 60 | | | |
| | | S glass-based glass cloth | | Percent by mass | | | | | | | | |
| | | E glass-based glass cloth | | Percent by mass | | | | | | | 60 | 60 |
| | | Average refractive index | | — | 1.511 | 1.511 | 1.510 | 1.511 | 1.521 | 1.511 | 1.559 | 1.557 |
| | | Refractive index difference | | — | 0.003 | 0.008 | 0.009 | 0.017 | 0.022 | 0.002 | 0.008 | 0.005 |
| | | Cross-section ratio | | — | 1.35 | 1.32 | 1.21 | 1.25 | 1.11 | 1.35 | 1.35 | 1.32 |
| | | Ratio of the number of glass yarns | | — | 1.16 | 1.15 | 1.10 | 1.12 | 1.05 | 1.16 | 1.16 | 1.15 |
| | | Twist number | MD direction | Z/inch | 0.5 | 1.0 | 1.0 | 1.0 | 1.0 | 1.0 | 1 | 1 |
| | | | TD direction | Z/inch | 0.5 | 1.0 | 1.0 | 1.0 | 1.0 | 1.0 | 1 | 1 |
| Smooth | Resin monomer | Alicyclic epoxy resin | E-DOA | Parts by mass | 100 | — | 100 | | | | 100 | 100 |
| layer | Curing agent | Optical cation polymerization initiator | SP-170 | Parts by mass | 1 | — | 1 | | | | 1 | 1 |

| Gas barrier | Silicon compound | SiOxNy | — | ◯ | ◯ | ◯ | | | | ◯ | ◯ |
|---|---|---|---|---|---|---|---|---|---|---|---|
| layer | | x | — | 1.5 | 0 | 0.5 | | | | 1.5 | 1.5 |
| | | y | — | 0.5 | 1.3 | 2 | | | | 0.5 | 0.5 |
| | | x/(x + y) | — | 0.75 | 0 | 0.20 | | | | 0.75 | 0.75 |
| | Zinc oxide | ZnO | — | | | | ◯ | | | | |
| | Ferric oxide (III) | Fe₂O₃ | — | | | | | ◯ | | | |
| Tm-Td | | | ° C. | 1308 | 1420 | 1415 | 1645 | 1185 | — | 1308 | 1308 |
| Evaluation | Abbe number of cured resin material | | — | 52 | 50 | 51 | 52 | 53 | 52 | 38 | 40 |
| results | Average thickness | μm | 95 | 97 | 97 | 97 | 98 | 97 | 97 | 98 | |
| | Dimension change due to humidity | MD direction | ppm | 47 | 35 | 44 | 42 | 42 | 464 | 42 | 44 |
| | | TD direction | ppm | 50 | 39 | 47 | 47 | 48 | 525 | 49 | 48 |
| | | Dimension change | — | 1.06 | 1.11 | 1.08 | 1.13 | 1.14 | 1.13 | 1.15 | 1.09 |
| | | TD/MD ratio | | | | | | | | | |
| | Haze (average of nine points) | \textcircled{1} Initial value | % | 1.6 | 2.3 | 2.7 | 3.5 | 3.5 | 3.5 | 5.1 | 5.3 |
| | | \textcircled{2} After 24 hours | % | 1.7 | 3.5 | 4.1 | 5.7 | 5.9 | 5.7 | 8.2 | 8.8 |
| | | treatment | | | | | | | | | |
| | | \textcircled{2} − \textcircled{1} | % | 0.1 | 1.2 | 1.4 | 2.2 | 2.4 | 2.2 | 3.1 | 3.5 |

| | | | | | | | | | |
|---|---|---|---|---|---|---|---|---|---|
| Water vapor permeation rate | g/m²/day/40° C., 90% RH | <0.01 | 0.18 | 0.15 | 0.25 | 0.26 | 10< | <0.01 | <0.01 |
| Oxgen permeation rate | cm³/m²/day/1 atm/23° C. | <0.1 | 10< | <0.1 | 10< | 10< | 10< | <0.1 | <0.1 |
| Abrasion resistance | — | A | A | B | C | C | C | A | A |

As is clear from Tables 3 and 4, in the transparent composite substrate obtained in each of the examples, the haze value is small and the change amount of haze after the humidity treatment is also small. Further, in the transparent composite substrate obtained in each of the examples, the difference of the dimension changes (the anisotropy of dimension change) between the weaving directions is small. In addition, it is confirmed that it is possible to improve the abrasion resistance by optimizing the abundance ratio of oxygen atoms and nitrogen atoms in the silicon compound forming the gas barrier layer and setting “Tm−Td” to be within a predetermined range. Therefore, it becomes apparent that the transparent composite substrate obtained in each of the examples has superior optical characteristics and can keep the superior optical characteristics even under harsh environments over the long term.

On the other hand, some transparent composite substrates obtained in the comparative examples have large haze values. Further, in some transparent composite substrates obtained in the comparative examples, the haze values are significantly changed due to the humidity treatment. In addition, although the haze values of the transparent composite substrates obtained in the comparative examples are small at the time of manufacturing, it becomes apparent that the haze values of the transparent composite substrates are rapidly deteriorated due to an acceleration test such as the humidity treatment. Since some transparent composite substrates obtained in the comparative examples have “Tm−Td” being largely-outside the predetermined range, a large refractive index difference of the glass cloth, a large water vapor permeation rate or a large coefficient of linear expansion, it can be guessed that these factors lead to the deterioration of haze. Further, it becomes clear that the abrasion resistance is deteriorated in a case where a material other than the silicon compound is used as the gas barrier layer.

TABLE 5

| | | | | | Ex. | Ex. | Ex. | Ex. | Ex. | Ex. | Ex. | Ex. | Ex. |
|---|---|---|---|---|---|---|---|---|---|---|---|---|---|
| | Conditions for manufacturing transparent composite substrate | | | | 1C | 2C | 3C | 4C | 5C | 6C | 7C | 8C | 9C |
| Composite | Resin monomer | Alicyclic epoxy resin | E-DOA | Parts by mass | 96 | 40 | | | | 96 | 96 | 96 | 96 |
| layer | | | E-BP | Parts by mass | | 57 | 100 | 95 | | | | | |
| | | Alicyclic acrylic resin | IRR-214K | Parts by mass | | | | | 100 | | | | |
| | | Disphenol-A type epoxy resin | EPIKOTE 828 | Parts by mass | | | | | | | | | |
| | | Silsesquioxane-based | OX-SQ-H | Parts by mass | 4 | 3 | | 5 | | 4 | 4 | 4 | 4 |
| | | compound | | | | | | | | | | | |
| | Curing agent | Optical cation polymerization | SP-170 | Parts by mass | 1 | 1 | | 1 | | 1 | | 1 | 1 |
| | | initiator | | | | | | | | | | | |
| | | Thermal cation | SI-100L | Parts by mass | | | 1 | | | | 1 | | |
| | | polymerization initiator | | | | | | | | | | | |
| | | Optical radical polymerization | Irgacure184 | Parts by mass | | | | | 1 | | | | |
| | | initiator | | | | | | | | | | | |
| | Solvent | Methyl isobutyl ketone | | Parts by mass | 25.25 | 25.25 | | | | 25.25 | 25.25 | 25.25 | 25.25 |
| | Refractive index of matrix resin | | | — | 1.510 | 1.512 | 1.522 | 1.510 | 1.529 | 1.511 | 1.512 | 1.510 | 1.511 |
| | Glass cloth | NE glass-based glass cloth | | Percent by mass | 65 | 65 | | 65 | | 65 | 65 | 65 | 65 |
| | | T glass-based glass cloth | | Percent by mass | | | 65 | | | | | | |
| | | S glass-based glass cloth | | Percent by mass | | | | | 65 | | | | |
| | | E glass-based glass cloth | | Percent by mass | | | | | | | | | |
| | | Average refractive index | | — | 1.511 | 1.511 | 1.522 | 1.510 | 1.529 | 1.512 | 1.511 | 1.511 | 1.511 |
| | | Refractive index difference | | — | 0.002 | 0.004 | 0.007 | 0.003 | 0.006 | 0.008 | 0.003 | 0.002 | 0.003 |
| | | Cross-section ratio | | — | 1.35 | 1.27 | 1.38 | 1.23 | 1.06 | 1.08 | 1.32 | 1.35 | 1.35 |
| | | Ratio of the number of glass yarns | | — | 1.16 | 1.13 | 1.17 | 1.11 | 1.03 | 1.04 | 1.15 | 1.16 | 1.16 |
| | | Twist number | MD direction | Z/inch | 1.0 | 1.0 | 1.0 | 1.0 | 1.0 | 1.0 | 1.0 | 1.5 | 0.5 |
| | | | TD direction | Z/inch | 1.0 | 1.0 | 1.0 | 1.0 | 1.0 | 1.0 | 1.0 | 1.5 | 0.5 |
| Smooth | Resin monomer | Alicyclic epoxy resin | E-DOA | Parts by mass | 100 | 100 | 100 | 100 | 100 | 100 | 100 | 100 | 100 |
| layer | Curing agent | Optical cation polymerization | SP-170 | Parts by mass | 1 | 1 | 1 | 1 | 1 | 1 | 1 | 1 | 1 |
| | | initiator | | | | | | | | | | | |

| Gas barrier | Silicon compound | SiOxNy | — | ◯ | ◯ | ◯ | ◯ | ◯ | ◯ | ◯ | ◯ | ◯ |
|---|---|---|---|---|---|---|---|---|---|---|---|---|
| layer | | x | — | 1.5 | 1.8 | 1.2 | 2 | 1 | 1.5 | 0.6 | 1.5 | 1.5 |
| | | y | — | 0.5 | 0.2 | 0.8 | 0 | 1 | 1 | 0.9 | 0.5 | 0.5 |
| | | x/(x + y) | — | 0.75 | 0.90 | 0.60 | 1.00 | 0.50 | 0.60 | 0.10 | 0.75 | 0.75 |
| | Zinc oxide | ZnO | — | | | | | | | | | |
| | Ferric oxide(III) | Fe₂O₃ | — | | | | | | | | | |
| Tm-Td | | | ° C. | 1308 | 1285 | 1330 | 1320 | 1345 | 1380 | 1360 | 1308 | 1308 |
| Evaluation | Abbe number of cured resin material | | — | 52 | 51 | 50 | 51 | 50 | 51 | 52 | 51 | 50 |
| results | Average thickness | | μm | 97 | 96 | 98 | 99 | 98 | 98 | 96 | 99 | 95 |
| | Dimension change due to humidity | MD direction | ppm | 37 | 40 | 36 | 40 | 48 | 47 | 38 | 34 | 43 |
| | | TD direction | ppm | 40 | 43 | 40 | 44 | 50 | 50 | 39 | 37 | 46 |
| | | Dimension change | — | 1.07 | 1.06 | 1.11 | 1.09 | 1.05 | 1.06 | 1.04 | 1.09 | 1.06 |
| | | TD/MD ratio | | | | | | | | | | |
| | Haze (average of nine points) | \textcircled{1} Initial value | % | 2.1 | 1.7 | 1.9 | 2.2 | 2.3 | 1.8 | 2.0 | 2.7 | 1.6 |
| | | \textcircled{2} After 24 hours treat- | % | 2.3 | 1.8 | 2.0 | 2.5 | 2.8 | 2.4 | 2.8 | 2.9 | 1.7 |
| | | ment | | | | | | | | | | |
| | | \textcircled{2} − \textcircled{1} | % | 0.2 | 0.1 | 0.1 | 0.3 | 0.5 | 0.6 | 0.8 | 0.2 | 0.1 |

| | | | | | | | | | | |
|---|---|---|---|---|---|---|---|---|---|---|
| Water vapor permeation rate | g/m²/day/40° C., 90% RH | <0.01 | <0.01 | <0.01 | 0.01 | 0.01 | 0.02 | 0.06 | <0.01 | <0.01 |
| Oxgen permeation rate | cm³/m²/day/1 atm/23° C. | <0.1 | <0.1 | <0.1 | 0.1 | 0.1 | 0.2 | <0.01 | <0.1 | <0.1 |

| | | | | | | | | | | |
|---|---|---|---|---|---|---|---|---|---|---|
| Coefficient of linear expansion | ppm/° C. | 11 | 12 | 9 | 11 | 10 | 11 | 12 | 12 | 11 |
| Abrasion resistance | — | A | A | A | B | B | B | B | A | A |

TABLE 6

| | | | | | Ex. | Ex. | Cf. | Cf. | Cf. | Cf. | Cf. | Cf. |
|---|---|---|---|---|---|---|---|---|---|---|---|---|
| | Conditions for manufacturing transparent composite substrate | | | | 10C | 11C | 1C | 2C | 3C | 4C | 5C | 6C |
| Composite | Resin monomer | Alicyclic epoxy resin | E-DOA | Parts by mass | 95 | 40 | 95 | | 96 | 96 | 39 | |
| layer | | | E-BP | Parts by mass | | 57 | | 100 | | | | 43 |
| | | Alicyclic acrylic resin | IRR-214K | Parts by mass | | | | | | | | |
| | | Bisphenol-A type epoxy resin | EPIKOTE 828 | Parts by mass | | | | | | | 61 | 57 |
| | | Silsesquioxane-based compound | OX-SQ-H | Parts by mass | 5 | 3 | 5 | | 4 | 4 | | |
| | Curing agent | Optical cation polymerization initiator | SP-170 | Parts by mass | 1 | 1 | | | 1 | 1 | | |
| | | Thermal cation polymerization initiator | SI-100L | Parts by mass | | | 1 | 1 | | | | |
| | | Optical radical polymerization initiator | Irgacure184 | Parts by mass | | | | | | | 1 | 1 |
| | Solvent | Methyl isobutyl ketone | | Parts by mass | 25.25 | 25.25 | 25.25 | | 25.25 | 25.25 | 25.25 | |
| | Refractive index of matrix resin | | | — | 1.510 | 1.512 | 1.510 | 1.520 | 1.510 | 1.510 | 1.559 | 1.560 |
| | Glass cloth | NE glass-based glass cloth | | Percent by mass | 65 | 65 | 65 | | 65 | | | |
| | | T glass-based glass cloth | | Percent by mass | | | | 65 | | | | |
| | | S glass-based glass cloth | | Percent by mass | | | | | | | | |
| | | E glass-based glass cloth | | Percent by mass | | | | | | | 60 | 60 |
| | | Average refractive index | | — | 1.511 | 1.510 | 1.511 | 1.521 | 1.511 | 1.511 | 1.559 | 1.557 |
| | | Refractive index difference | | — | 0.008 | 0.009 | 0.017 | 0.022 | 0.002 | — | 0.008 | 0.005 |
| | | Cross-section ratio | | — | 1.32 | 1.21 | 1.25 | 1.11 | 1.35 | — | 1.35 | 1.32 |
| | | Ratio of the number of glass yarns | | — | 1.15 | 1.10 | 1.12 | 1.05 | 1.16 | — | 1.16 | 1.15 |
| | | Twist number | MD direction | Z/inch | 1.0 | 1.0 | 1.0 | 1.0 | 1.0 | — | 1 | 1 |
| | | | TD direction | Z/inch | 1.0 | 1.0 | 1.0 | 1.0 | 1.0 | — | 1 | 1 |
| Smooth | Resin monomer | Alicyclic epoxy resin | E-DOA | Parts by mass | — | 100 | | | | 100 | 100 | 100 |
| layer | Curing agent | Optical cation polymerization initiator | SP-170 | Parts by mass | — | 1 | | | | 1 | 1 | 1 |
| Gas barrier | Silicon compound | | SiOxNy | — | ◯ | ◯ | | | | ◯ | ◯ | ◯ |
| layer | | | x | — | 0 | 0.5 | | | | 1.5 | 1.5 | 1.5 |
| | | | y | — | 1.3 | 2 | | | | 0.5 | 0.5 | 0.5 |
| | | | x/(x + y) | — | 0 | 0.20 | | | | 0.75 | 0.75 | 0.75 |
| | Zinc oxide | | ZnO | — | | | ◯ | | | | | |
| | Ferric oxide(III) | | Fe₂O₃ | — | | | | ◯ | | | | |
| Tm-Td | | | | ° C. | 1420 | 1415 | 1645 | 1185 | — | 1308 | 1308 | 1308 |

| | | | | | | | | | | | |
|---|---|---|---|---|---|---|---|---|---|---|---|
| Evaluation | Abbe number of cured resin material | | — | 51 | 52 | 53 | 52 | 38 | 52 | 38 | 40 |
| results | Average thickness | | μm | 97 | 97 | 97 | 98 | 97 | 105 | 97 | 98 |
| | Dimension change due to humidity | MD direction | ppm | 32 | 40 | 39 | 39 | 428 | 184 | 39 | 41 |
| | | TD direction | ppm | 36 | 43 | 44 | 45 | 485 | 182 | 45 | 44 |
| | | Dimension change | — | 1.11 | 1.08 | 1.13 | 1.14 | 1.13 | 0.99 | 1.15 | 1.09 |
| | | TD/MD ratio | | | | | | | | | |
| | Haze (average of nine points) | \textcircled{1} Initial value | % | 2.3 | 2.7 | 3.5 | 3.5 | 3.5 | 1.1 | 5.1 | 5.3 |
| | | \textcircled{2} After 24 hours | % | 3.5 | 4.1 | 5.7 | 5.9 | 5.7 | 1.1 | 8.2 | 8.8 |
| | | treatment | | | | | | | | | |
| | | \textcircled{2} − \textcircled{1} | % | 1.2 | 1.4 | 2.2 | 2.4 | 2.2 | 0 | 3.1 | 3.5 |

| | | | | | | | | | |
|---|---|---|---|---|---|---|---|---|---|
| Water vapor permeation rate | g/m²/day/40° C., 90% RH | 0.18 | 0.15 | 0.25 | 0.26 | 10< | <0.01 | <0.01 | <0.01 |
| Oxgen permeation rate | cm³/m²/day/1 atm/23° C. | 10< | <0.1 | 10< | 10< | 10< | <0.1 | <0.1 | <0.1 |

| | | | | | | | | | |
|---|---|---|---|---|---|---|---|---|---|
| Coefficient of linear expansion | ppm/° C. | 12 | 11 | 11 | 9 | 11 | 59 | 15 | 13 |
| Abrasion resistance | — | A | B | C | C | C | A | A | A |

As is clear from Tables 5 and 6, in the transparent composite substrate obtained in each of the examples, the haze value is small and the change amount of haze after the humidity treatment is also small. Further, in the transparent composite substrate obtained in each of the examples, CHE difference (the anisotropy of dimension change) between the weaving directions is small. Furthermore, the water vapor permeation rate and the coefficient of linear expansion are also small. Thus, it becomes apparent that the transparent composite substrate obtained in each of the examples has superior weather resistance and can suppress the influence of changing environments on the optical characteristics to the minimum. Therefore, it becomes apparent that the transparent composite substrate of the present invention has superior optical characteristics and can keep the superior optical characteristics even under harsh environments over the long term. Further, it is confirmed that it is possible to suppress the significant deterioration of the optical characteristics even after the abrasion test by optimizing the abundance ratio of oxygen atoms and nitrogen atoms in the silicon compound forming the gas barrier layer.

On the other hand, some transparent composite substrates obtained in the comparative examples have large haze values. Further, in some transparent composite substrates obtained in the comparative examples, the haze values are significantly changed due to the humidity treatment. In addition, although the haze values of the transparent composite substrates obtained in the comparative examples are small at the time of manufacturing, it becomes apparent that the haze values of the transparent composite substrates are rapidly deteriorated due to an acceleration test such as the humidity treatment. Since some transparent composite substrates obtained in the comparative examples have a large refractive index difference of the glass cloth, a large water vapor permeation rate or a large coefficient of linear expansion, it can be guessed that these factors lead to the deterioration of haze. Further, it becomes clear that the optical characteristics are slightly deteriorated due to the abrasion test in a case where a material other than the silicon compound is used as the gas barrier layer.

Therefore, according to the present invention, it becomes apparent that the transparent composite substrate has superior optical characteristics and can keep the superior optical characteristics even under harsh environments over the long term.

### INDUSTRIAL APPLICABILITY

According to the present invention, it is possible to provide a transparent composite substrate having superior optical characteristic by providing a composite layer containing a glass cloth formed of an assembly of glass fibers, which has a variation in a refractive index, and a resin material impregnated in the glass cloth in the transparent composite substrate, the resin material having an Abbe number of equal to or larger than 45, and setting a difference between a maximum value and a minimum value of the refractive index to be equal to or less than 0.01. For the reasons stated above, the present invention is industrially applicable.

What is claimed is:

1. A transparent composite substrate, comprising:
a composite layer containing a glass cloth formed of an assembly of glass fibers and a resin material impregnated in the glass cloth, the resin material having an Abbe number of equal to or larger than 45,
wherein the assembly of the glass fibers itself has a variation in a refractive index, and a difference between a maximum value and a minimum value of the refractive index is equal to or less than 0.01.

2. The transparent composite substrate as claimed in claim 1, wherein the resin material contains an alicyclic epoxy resin or an alicyclic acrylic resin as a major component thereof.

3. The transparent composite substrate as claimed in claim 1, wherein a water vapor permeation rate of the transparent composite substrate measured according to a method defined in “JIS K 7129 B” is equal to or less than 0.1 [g/m²/day/40° C., 90% RH].

4. The transparent composite substrate as claimed in claim 3, wherein an average coefficient of linear expansion of the transparent composite substrate at a temperature of 30 to 150° C. is equal to or less than 40 ppm/° C.

5. The transparent composite substrate as claimed in claim 1, further comprising a surface layer provided on at least one surface side of the composite layer and having at least transparency and gas barrier property.

6. The transparent composite substrate as claimed in claim 5, wherein the surface layer is formed of an inorganic material.

7. The transparent composite substrate as claimed in claim 6, wherein when a melting point of the inorganic material is defined as “Tm” [° C.] and a temperature at which a weight of a major component contained in the resin material decreases by 5% is defined as “Td” [° C.], “Tm” and “Td” satisfy a relationship of 1200<(Tm−Td)<1400.

8. The transparent composite substrate as claimed in claim 6, wherein the inorganic material contains a silicon compound.

9. The transparent composite substrate as claimed in claim 8, wherein the silicon compound is represented by a chemical formula of SiOₓN_{y}, and
wherein “x” and “y” in the chemical formula of SiOₓN_{y} respectively satisfy conditions of 1≦x≦2 and 0≦y≦1.

10. The transparent composite substrate as claimed in claim 8, wherein the silicon compound contains an oxygen atom and a nitrogen atom.

11. The transparent composite substrate as claimed in claim 10, wherein the silicon compound is represented by a chemical formula of SiOₓN_{y}, and
“x” and “y” in the chemical formula of SiOₓN_{y} satisfy conditions of y>0 and 0.3<x/(x+y)≦1.

12. The transparent composite substrate as claimed in claim 5, wherein an average thickness of the surface layer is in the range of 10 to 500 nm.

13. The transparent composite substrate as claimed in claim 5, further comprising an intermediate layer provided between the composite layer and the surface layer and formed of a resin material.

14. A display element substrate having the transparent composite substrate defined by claim 1.
